(19) United States
(12) Patent Application Publication
(10) Pub. No.: US 2025/0028580 A1
(43) Pub. Date: Jan. 23, 2025

(54) SYSTEM AND METHODS FOR APPLICATION INTERACTION WITH POLYSPATIAL APPLICATION GRAPHS

(71) Applicant: Unity Technologies SF, San Francisco, CA (US)

(72) Inventors: Timothy S. Condon, South San Francisco, CA (US); Vladimir Vukicevic, Auburn, CA (US); Ryan Goodrich, Redmond, WA (US)

(21) Appl. No.: 18/777,319

(22) Filed: Jul. 18, 2024

Related U.S. Application Data
(60) Provisional application No. 63/527,520, filed on Jul. 18, 2023.

(51) Int. Cl. G06F 9/54; G06F 3/04815

(52) U.S. Cl. CPC G06F 9/543; G06F 3/04815

(57) ABSTRACT

A system and method for application interaction and/or communication, the system maintaining a polyspatial input/output (I/O) graph specifying how applications can interact within a unified logical space. In some embodiments, the polyspatial graph specifies an application hierarchy comprising at least a host application, one or more hosted applications to be executed within the host application, one of the hosted applications corresponding to an intermediate host application for an additional application. The host application and the one or more hosted applications are executed, the executing comprising: receiving, at the host application, input to be transmitted to the one or more hosted applications; coordinating, by the host application, interactions among the one or more hosted applications; generating, by the host application, of an aggregated output based on outputs of the hosted applications and comprising a scene graph; and displaying, by the host application, of a display based on the generated aggregated output.

### CROSS REFERENCE TO RELATED APPLICATIONS

This application claims the benefit of U.S. Provisional Application 63/527,520, filed on Jul. 18, 2023, which is hereby incorporated by reference in its entirety.

### TECHNICAL FIELD

The disclosed subject matter relates generally to the technical field of software applications and, in one specific example, to a system, method and API for application interaction and/or communication.

### BACKGROUND

Developers and users are interested in ever more complex user experiences including cross-application aggregation, interaction and queries, as well as application ecosystems with complex topologies. Areas of interest include multi-player user games, educational technologies, design and business software, and so forth.

### BRIEF DESCRIPTION OF THE SEVERAL VIEWS OF THE DRAWINGS

Some embodiments are illustrated by way of example and not limitation in the figures of the accompanying drawings.

FIG. 1 is a network diagram illustrating a system within which various example embodiments may be deployed.

FIG. 2 is a diagrammatic representation of a view of an application interaction system, according to some embodiments.

FIG. 3 is a diagrammatic representation of an application architecture, according to some embodiments.

FIG. 4 is a diagrammatic representation of a command pipeline as implemented in an application interaction system, according to some embodiments.

FIG. 5 is a diagrammatic representation of a command pipeline as implemented in an application interaction system, according to some embodiments.

FIG. 6 is a diagrammatic representation of a view of an application interaction system, according to some embodiments.

FIG. 7 is a diagrammatic representation of a view of an application interaction system, according to some embodiments.

FIG. 8 is a diagrammatic representation of a view of an application interaction system, according to some embodiments.

FIG. 9 is a diagrammatic representation of a view of an application interaction system, according to some embodiments.

FIG. 10 is a diagrammatic representation of a view of an application interaction system, according to some embodiments.

FIG. 11 is a diagrammatic representation of views of an application interaction system, according to some embodiments.

FIG. 12 is a diagrammatic representation of a view of an application interaction system, according to some embodiments.

FIG. 13 is a diagrammatic representation of a view of an application interaction system, according to some embodiments.

FIG. 14 is a diagrammatic representation of a view of an application interaction system, according to some embodiments.

FIG. 15 is a diagrammatic representation of a view of an application interaction system, according to some embodiments.

FIG. 16 is an illustration of several views of an application interaction system, according to some embodiments.

FIG. 17 is an illustration of several views of an application interaction system, according to some embodiments.

FIG. 18 is an illustration of several views of an application interaction system, according to some embodiments.

FIG. 19 is an illustration of several views of an application interaction system, according to some embodiments.

FIG. 20 is an illustration of a view of an application interaction system, according to some embodiments.

FIG. 21 is an illustration of a view of an application interaction system, according to some embodiments.

FIG. 22 is an illustration of a view of an application interaction system, according to some embodiments.

FIG. 23 is an illustration of a view of an application interaction system, according to some embodiments.

FIG. 24 is a diagrammatic representation of a view of an application interaction system, according to some embodiments.

FIG. 25 is a flowchart illustrating a method as implemented by an application interaction system, according to some embodiments.

FIG. 26 is a block diagram illustrating an example of a software architecture that may be installed on a machine, according to some embodiments.

FIG. 27 is a block diagram illustrating components of a machine, according to some embodiments, able to read instructions from a machine-readable medium (e.g., a machine-readable storage medium) and perform any one or more of the methodologies discussed herein.

### DETAILED DESCRIPTION

Current systems enabling application interaction or communication have constraints that frustrate developers and users interested in ever more complex experiences such as cross-application aggregation, interaction and/or querying, as well as in ecosystems with complex application topologies. Many current 3D applications run within a dedicated window with minimal cross-application interactions. For example, many games default to running in full-screen mode, and even 3D applications like modeling and CAD software-based operating system (OS) windows offer limited interaction with other applications beyond copy and paste capabilities. Thus, there is a need for an application interaction system that enables richer inter-application interaction that would allow for better, more interesting experiences for users and for developers.

Furthermore, many current applications provide a single level of 3D content nesting. Examples include operating systems that can host one or more 3D applications, 3D games with plugin support, and 3D software applications supporting user-generated content. However, current systems do not allow for arbitrarily deep nesting of content and do not solve the nesting problem in a general way. Current systems do not support hosting applications both locally and remotely, and do not support an easy way to allow for cross-app queries and interactions.

Additionally, while systems using networked scene graphs exist in a variety of domains, they typically synchronize a single scene graph (e.g., corresponding to only one application), across network nodes. Large scale network games such as massively multi-player online games (MMOGs) often use a distributed scene graph to spread a large, connected world across multiple servers to improve scale, but the goal is typically achieved by subdividing a large scene graph into independent parts. Current solutions do not facilitate aggregating multiple scenes from separate applications, or other sources, such as digital twins or the real world, and/or separate nodes into a holistic representation.

Example embodiments herein refer to an application interaction system that addresses the technical challenges described above, and others, by using a polyspatial input/output (I/O) graph to define ways in which applications (apps) can coexist and interact within a single logical space, as well as be nested hierarchically, optionally across a network. The polyspatial graph (e.g., a hierarchical graph) is a graph of applications and hosts. Applications can be nested hierarchically—for example, a compliant app (e.g., an app integrated in the application interaction system) can recursively run inside another host compliant app, while the system delimits how input and output pass between app-specific layers to ensure consistency. By allowing applications, such as 2D and 3D applications, to be connected hierarchically, the system enables nested multitasking (e.g., nested 3D multitasking). Furthermore, applications can be split and/or distributed across multiple hosts for completing certain operations, such as rendering operations. The results of rendering can be then combined for visualization purposes. Splitting and/or distributing applications across hosts can be based on spatial proximity (near vs. far) and/or on rate of update (e.g., fast (and cheap) vs. slow (and expensive)), as further seen below.

As indicated above, multiple applications can share a logical 3D space. By maintaining a common virtual 3D model, the application interaction system enables cross-app queries and interactions. The application interaction system provides a common interface for how applications can interact with each other while maintaining security. Furthermore, a logical space (e.g., a logical 3D space) can be split across multiple hosts in order to divide up tasks for a specific application, such as rendering work.

The application interaction system explicitly distinguishes between application core logic and platform-specific I/O requirements. In some embodiments, application core logic is associated with a universal server application that adheres to a universal server specification corresponding to a framework for building general network-capable software applications. In some embodiments, a universal host is a separate standalone application that can connect to, display and/or interact with any application that adheres to a universal server specification. As mentioned above, applications can host other applications, and/or applications can be arbitrarily nested (e.g., the application interaction system enables hierarchical structures of applications). In some embodiments, the application interaction system can be implemented as a universal server and host system that allows for complex application topologies (e.g., such as arbitrary nesting of applications). In some embodiments, a universal server and host system can be implemented as an application interaction system in which applications are networked or connected to instances of the same of different applications by using a universal host and server connection model.

In some embodiments, the application interaction system enables one or more users in a multi-user networked environment to maintain a unique local polyspatial graph (e.g., a hierarchical graph representing all apps running on their local device), but each resident application can optionally maintain one or more network connections to other application instances running on other users' systems and thus part of those users' local polyspatial graphs. Such cross-user or remote connections together with the system's ability to present each user with a consistent view of their own subgraph enables the system to handle multiple users and multiple apps within a comprehensive framework.

Furthermore, in some embodiments, the application interaction system enables a user, device or endpoint to maintain one comprehensive scene graph, corresponding to all scene graph content (e.g., from a remote server, etc.) replicated by a host application on a respective device. Thus, data transmitted over the network can be centralized and/or cached only once. However, the application interaction system enables the automatic creation and/or maintenance of multiple views of the same scene graph data, corresponding for example to multiple 2D windows and/or multiple 3D volumes. Each such view is enabled by the application interaction system maintaining (or enabling the maintenance of) a partial scene graph (e.g., one per view, window or volume). For example, the partial scene graph only includes content being visible and/or displayed with respect to a particular viewpoint and/or at a particular time.

By separating an application's logic from its platform-specific I/O requirements, the application interaction system provides improved platform compatibility and/or hardware support. Furthermore, any software program can become a software platform that can host other apps, recursively. An application can therefore host or enable third party plugins, while the application itself is hosted within a shared world shell application that allows simultaneous interaction with multiple applications potentially involved in multi-user networked setup. In some embodiments, the application interaction system can enable developers to build bespoke shared world operating systems based on a provided generalized shell. For example, an augmented reality (AR) headset developer could provide operating system (OS)-level features for displaying many apps simultaneously on top of the real world.

In some embodiments, the application interaction system's treatment of an application as a generic or universal server, while treating a host as a generic client, enables simplified, generic networking for any target application. Each application can become an authoritative server, while (additional) hosts can serve as terminals for content provided by the authoritative server. In some embodiments, hosts or host applications can aggregate different scenes, same-type or mixed-type content from separate hosted applications into one or more holistic representations, thereby enabling networked real time multitasking (e.g., 3D multitasking). Additionally, the application interaction system can thus address the limitations of traditional systems that typically synchronize only one scene graph across nodes, as outlined above.

By enabling applications to host other applications, the application interaction system enables fully featured, sandboxed plugins (aka user-generated content) that can run within other apps. Sandboxing applications such as plugins in their own process while allowing them to connect via local sockets delegates responsibilities like system resource management and security on the underlying operating system (OS). In some embodiments, a plugin developed once can run in multiple different applications that are part of the application interaction system (e.g., compliant applications), rather than need additional application-specific customization. In some embodiments, the application interaction system can enable experiences such as allowing streaming live play on Twitch or a similar platform by providing built-in facilities for “observer-only” game clients.

Overall, while current systems and architectures enable multiple users to use single applications (e.g., networked games) or integrate multiple applications in the same environment (e.g., operating system), the application interaction system enables both multiple applications and multiple users to interact within a unified framework, while allowing for arbitrarily complex topologies including nested applications, hierarchical application structures, and so forth. The application interaction system enables both 3D multitasking and novel cross-app interactions. Additionally, any software that conforms to the system's requirements becomes a software platform that can run inside any other conforming software platform and is automatically networkable.

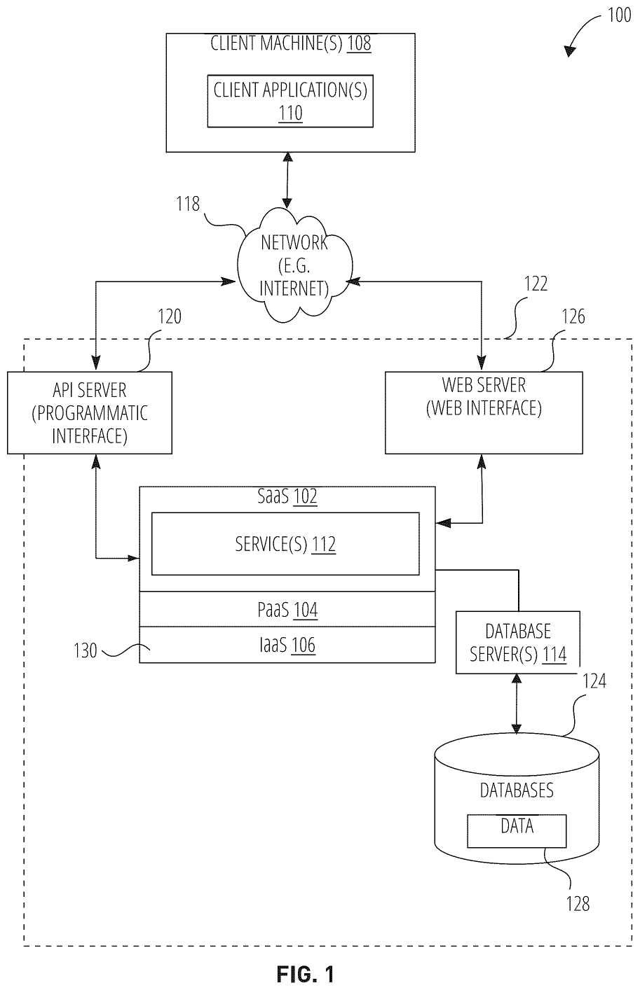

FIG. 1 is a network diagram depicting a system 100 within which various example embodiments described herein may be deployed. A networked system 122 in the example form of a cloud computing service, such as Microsoft Azure or other cloud service, provides server-side functionality, via a network 118 (e.g., the Internet or Wide Area Network (WAN)) to one or more endpoints (e.g., client machine(s) 108). FIG. 1 illustrates client application(s) 110 on the client machine(s) 108. Examples of client application(s) 110 may include a web browser application, such as the Internet Explorer browser developed by Microsoft Corporation of Redmond, Washington or other applications supported by an operating system of the device, such as applications supported by Windows, iOS or Android operating systems. Examples of such applications include e-mail client applications executing natively on the device, such as an Apple Mail client application executing on an iOS device, a Microsoft Outlook client application executing on a Microsoft Windows device, or a Gmail client application executing on an Android device. Examples of other such applications may include calendar applications, file sharing applications, contact center applications, digital content creation applications (e.g., game development applications) or game applications. Each of the client application(s) 110 may include a software application module (e.g., a plug-in, add-in, or macro) that adds a specific service or feature to the application.

An API server 120 and a web server 126 are coupled to, and provide programmatic and web interfaces respectively to, one or more software services, which may be hosted on a software-as-a-service (SaaS) layer or platform 102. The SaaS platform may be part of a service-oriented architecture, being stacked upon a platform-as-a-service (PaaS) layer 104 which, may be, in turn, stacked upon an infrastructure-as-a-service (IaaS) layer 106 (e.g., in accordance with standards defined by the National Institute of Standards and Technology (NIST)).

While the applications (e.g., service(s)) 112 are shown in FIG. 1 to form part of the networked system 122, in alternative embodiments, the applications 112 may form part of a service that is separate and distinct from the networked system 122.

Further, while the system 100 shown in FIG. 1 employs a cloud-based architecture, various embodiments are, of course, not limited to such an architecture, and could equally well find application in a client-server, distributed, or peer-to-peer system, for example. The various server services or applications 112 could also be implemented as standalone software programs. Additionally, although FIG. 1 depicts machine(s) 108 as being coupled to a single networked system 122, it will be readily apparent to one skilled in the art that client machine(s) 108, as well as client application(s) 110 (such as game applications), may be coupled to multiple networked systems, such as payment applications associated with multiple payment processors or acquiring banks (e.g., PayPal, Visa, MasterCard, and American Express).

Web applications executing on the client machine(s) 108 may access the various applications 112 via the web interface supported by the web server 126. Similarly, native applications executing on the client machine(s) 108 may access the various services and functions provided by the applications 112 via the programmatic interface provided by the API server 120. For example, the third-party applications may, utilizing information retrieved from the networked system 122, support one or more features or functions on a website hosted by the third party. The third-party website may, for example, provide one or more promotional, marketplace or payment functions that are integrated into or supported by relevant applications of the networked system 122.

The server applications may be hosted on dedicated or shared server machines (not shown) that are communicatively coupled to enable communications between server machines. The server applications 112 themselves are communicatively coupled (e.g., via appropriate interfaces) to each other and to various data sources, so as to allow information to be passed between the server applications 112 and so as to allow the server applications 112 to share and access common data. The server applications 112 may furthermore access one or more databases 124 via the database server(s) 114. In example embodiments, various data items are stored in the databases 124, such as the system's data items 128. In example embodiments, the system's data items may be any of the data items described herein.

Navigation of the networked system 122 may be facilitated by one or more navigation applications. For example, a search application (as an example of a navigation application) may enable keyword searches of data items included in the one or more databases 124 associated with the networked system 122. A client application may allow users to access the system's data 128 (e.g., via one or more client applications). Various other navigation applications may be provided to supplement the search and browsing applications.

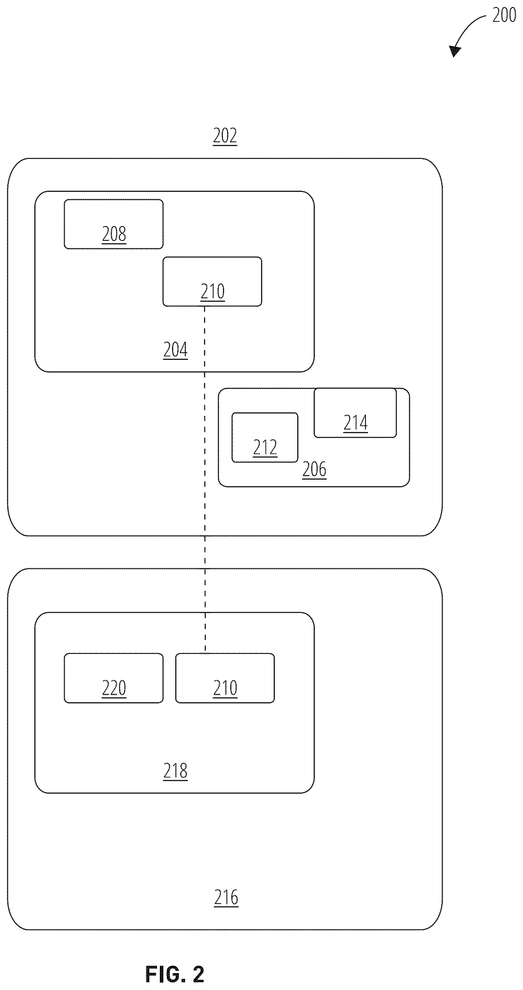

FIG. 2 is a diagrammatic representation of a view of an application interaction system 200, according to some embodiments. In some embodiments, applications 202-214 run on a first local device, while applications 216-220 run on a second local device. In some embodiments, a first instance of application 210 runs on the first local device, while a second instance of application 210 runs on the second device.

In some embodiments, given a user using a device, the application interaction system 200 uses a polyspatial graph to represent the connections or interactions among some or all applications (or application instances) running on the user's device or system. The application interaction system 200 organizes applications such as 2D and 3D applications as a hierarchical graph of applications (apps) and hosts. Applications can be arbitrarily nested within hosts, and applications can be hosts, resulting in the application interaction system 200 enabling hierarchical structures of applications. For example, applications 208 and 210 are hosted by application 204, while applications 212 and 214 are hosted by application 206. In turn, applications 204 and 206 are hosted by application 202, running on a first local device. Application 216, running on the second local device, hosts application 218 which in turn hosts applications 220 and 210. By using polyspatial graphs, the application interaction system 200 connects applications (such as 2D or 3D applications) hierarchically and/or enables nested multitasking. It allows any compliant app to run inside any other compliant app (recursively), and delimits how input and output pass between these layers to ensure consistency. In some embodiments, in a multi-user networked environment, the application interaction system enables each user to maintain a unique local multispatial graph (representing all apps running on their local device), but each resident app may optionally maintain one or more network connections to other app instances running on other users' systems (and thus in those users' local multispatial graphs). In some embodiments, a resident app can be networked or connected with an instance of the same app, or an instance of a different app. For example, an instance of application 210 runs on the first local device and a second instance of application 210 runs on the second local device. Cross-user or cross-device connections together with the system's ability to present each user with a consistent view of their own subgraph enables the application interaction system 200 to handle many users and many apps within a comprehensive framework. An app can be networked or connected to an instance of the same or a different app residing elsewhere by using traditional networking techniques (e.g., TCP/IP) or by implementing a universal host and server model, resulting in an even more general multi-application and/or multi-user 3d multitasking environment.

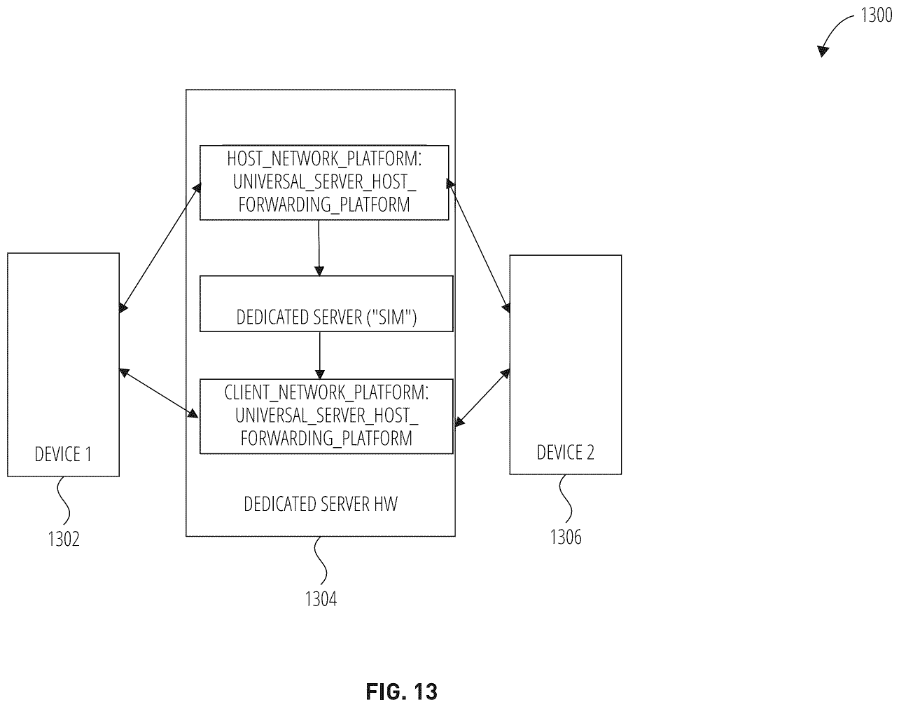

In some embodiments, each host aggregates and processes the output of its hosted applications, and dispatches input received by the host to its hosted applications. In some embodiments, such aggregated output from hosted applications takes the form of a logical scene graph (explicit or not). Applications process input, execute their own internal logic and/or simulation routines, and supply output commands back to their host(s). Applications run locally, or remotely over a network connection. Applications can be single-user applications or multi-user applications. As previously mentioned, an application can be a host for its own set of nested apps, enabling arbitrarily deep hierarchical nesting (see, for example, at least FIG. 13 for examples of applications running inside another application).

Each application is associated with one or more spaces that contain 2D and/or 3D geometry and content (for example, bounded or unbounded logical 2D or 3D cartesian spaces). Host applications and hosted applications exchange input and output between associated logical 3D spaces. Spaces can move, resize, and otherwise change shape independently, either as a result of user intervention or as a result of application-specific operations. Moving refers to translation or rotation operations, for example relative to an application's parent. Resizing refers to rescaling relative to an application parent. A host application can define how constituent or hosted applications are arranged, whether and how they are positioned, rotated, or scaled, whether they can or cannot interact, in which circumstances they can interact and/or what type of interactions are further subject to direct or indirect coordination by logic associated with the host application. In the following, example application arrangements or organization options are described.

In some embodiments, an application is assigned one or more dedicated volumes and/or windows, which it controls. Conflicts among applications are resolved or reconciled by a host application. For example, in cases where moving and/or resizing a volume causes overlaps in a logical space (such as a logical 3D space), a host application may resolve the overlap by using a priority-based ordering technique, a physics engine, or other means. In some embodiments, a priority-based technique can be deferring to the first application to have moved and/or resized a volume.

In some embodiments, an application is assigned to a unique layer with an unbounded extent. A final scene is generated by composing multiple layers (associated with multiple applications). In order to generate a coherent and cohesive scene, conflicts such as cross-layer overlaps implicating specific objects can be resolved using host-specific means or heuristics. For example, a shared physics simulation can separate and push apart individual overlapping objects.

In some embodiments, an application is associated with specific content and/or potential states. An application detects changes to the content and state, such as updated assets (e.g., modified textures), material property changes, transform changes and so forth. The application propagates detected content and state changes to relevant hosts (such as parent hosts, connected hosts, etc.). In some embodiments, an application can render itself to one or more render targets. In some embodiments, render targets can be aggregated by one or more hosts.

In some embodiments, a host aggregates the output of its hosted applications. An example of output aggregation refers to constructing a local scene graph based on aggregate graphics content that enables local rendering and/or queries. In some embodiments, the application interaction system 200 builds and updates a unified physics model of the aggregate physics content of a set of hosted applications in order to enable queries, cross-application interaction, physics simulation, or conflict resolution (e.g., resolving illegal object overlaps). In some embodiments, audio received from multiple hosted applications can be mixed by the host application. In some embodiments, a host has its own local content, local user interface (UI), or other affordances, which can be incorporated into one or more aggregate representations being constructed at or by the host.

In some embodiments, each host processes input (such as button presses, cursor movement, joint tracking, etc.) and dispatches it appropriately to any of the applications it is hosting. A host can define its own heuristics and input models to determine how and when to dispatch input to its associated hosted applications. By separating core application logic from platform-specific I/O requirements associated with host functionality, the application interaction system 200 can provide improved platform compatibility and hardware support.

As indicated above, applications can share a logical 3D space that allows the application interaction system 200 to enable cross-app queries and interactions. In some embodiments, a logical 3D space can be split across multiple hosts in order to divide up tasks such as rendering work. For example, the application interaction system 200 can enable one or more subsets of a scene to be rendered to one or more render targets (or stereo render targets) directly by a server, and then sent as textures, images or video (in mono or stereo pairs) for direct display by a host. Rendered scene subsets can be transmitted to the host as textures on quads or other geometry, to be optionally combined with other 3D data via on-host local rendering.

In some embodiments, a scene subset can be offloaded to a worker host that renders this content and/or streams back the results for final display on the initiating host. Examples of such subsets can be selected based on spatial proximity (e.g., a part of the scene with more distant geometry with respect to a viewpoint), or based on frequency of change (e.g., global illumination data has a lower rate of change than other scene data). In some embodiments, rendering can use intermediate data that is expensive to compute, such as irradiance volumes, or light/environment probes, or lightmaps, as in the case of global illumination data.

In some embodiments, a shared logical 3D space can enable an environment shared across multiple clients and/or a host, and enable the host to provide an experience to the end user that can be simulated, or rendered, on multiple computers in multiple ways. For example, a first client can simulate an environment. A second client can simulate an object in the environment. The first and second clients can transmit the respective simulation data to the host, which can simulate a player in the respective environment. In some embodiments, one or more computation requests related to objects in the environment or other aspects of the environment can be transmitted to one or more external clients, with the results being streamed back to the host. Clients can transmit data and/or results in multiple ways: streamed rendering commands, streamed framebuffers, and so forth. In some embodiments, a framebuffer can be produced via fixed pipeline rendering on a GPU. Alternatively, the framebuffer can be generated using Gaussian splatting, neural rendering techniques such as Neural Radiance Fields (NeRFs) (e.g., via a compute shader), and/or via a ray tracing renderer or path tracing renderer (e.g, on a CPU or a GPU cluster).

Intermediate nodes in an application hierarchy can simultaneously be hosted applications (with respect to their parents) and hosts (with respect to their children). An intermediate host performs content aggregation, but also forwards the aggregated content to its own host. An intermediate host dispatches inputs to its own local content and/or the appropriate nested applications.

In some embodiments, an intermediate node in an application hierarchy and/or application graph can refer to an intermediate representation corresponding to a local virtual scene graph maintained by a host application. The local virtual scene graph includes all the replicated scene graph content (e.g., received from a remote and/or server application). The application interaction system 200 enables the automatic construction of local partial scene graphs, each corresponding to a view (e.g., for a 2D camera, or a 3D volume camera). Each such local partial scene graph contains view-specific backing objects that correspond to objects visible from the corresponding camera's perspective—for example, culled objects are excluded. The partial scene graph encodes viewpoint-specific effects, such as geometry oriented toward the respective view point, particles baked to a mesh corresponding to said viewpoint, global illumination (GI) calculated in respective view's screen space, and so forth. Ensuring each host has a local virtual scene graph corresponding to a complete copy of the world thus enables view-dependent capabilities, and/or reduces bandwidth—for example, the application interaction system 200 can send only change deltas from a host to each sim. Furthermore, the application interaction system 200 can spawn new views quickly, and/or change viewpoint rapidly. Additionally, the application interaction system 200 can control the overhead imposed on the host or backend by limiting the set of concrete backing objects per view (e.g., using a predetermined maximum).

In some embodiments, an intermediate node in an application graph can refer to a mapping between representations at different granularity levels. For examples, a host application can receive one or more high-level asset or command representations of the scene (game objects, meshes, materials, high-level commands such as updates to scene assets and/or to components) and automatically map them to low-level representations (e.g., vertex buffers, index buffers, draw calls, pipeline state, shaders, low-level commands, and so forth). For example, low-level commands can be converted to API calls on device (e.g., setting pipeline state, issuing a draw call, etc.)

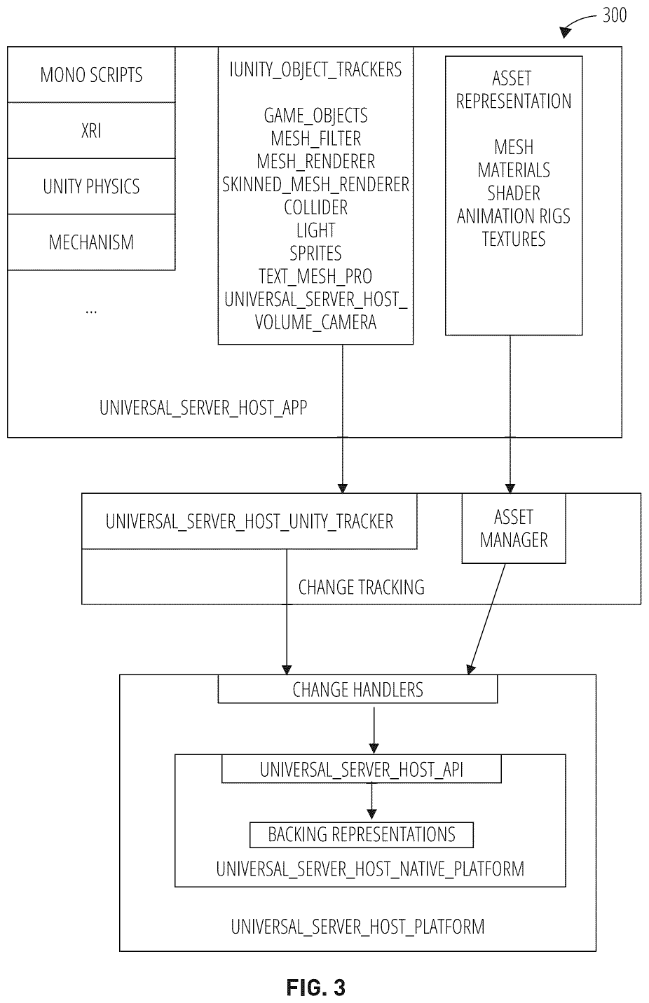

FIG. 3 is a diagrammatic representation 300 of an application architecture, according to some embodiments. In some embodiments, the architecture is a local architecture. In some embodiments, the application (e.g., a Universal Server-Host App) refers to a Unity game or application (as indicated above, a game or application created using the Unity Editor™ and/or including Unity Technologies' real-time engine runtime application or parts thereof). In some embodiments, the application refers to a program that implements a universal server specification. In some embodiments, the application implements a universal host specification.

In some embodiments, the application processes received input, updates its internal state, and runs app-specific simulation, and tracks and serializes changes to its output state as a result of received and processed input and the passage of time. In some embodiments, changes are encoded as scene graph commands, lifecycle commands, input commands, low-level graphics commands, and so forth. The determined changes can be handled by, in some embodiments, platforms that run on a specific local device or in editor. Lifecycle commands include commands such as “Begin/EndSession,” “Begin/EndConnection,” “Begin/EndFrame,” and so forth. Input commands include simple input commands such as mouse clicks, pointer movement (2d or 3D), button presses (keyboard or controller), sticks (game controller), and so forth. Input commands can also refer to more complex input sources, corresponding to head and joint transforms, AR planes, AR tracked images, AR Meshing, and so forth. Scene graph commands can include asset updates, component updates, and so forth.

Assets include meshes, materials, textures, shader and/or animation rig information, fonts, audio clips, low level GPU assets (e.g., including textures, buffers, pipeline state), and so forth. Examples of assets can be found in the “ASSETS” section of the GLOSSARY. Asset updates include newly created, modified or destroyed meshes, textures or materials, animation clips and/or graphs, updates to particle system properties, and so forth. Components refer to modular elements associated with game objects such as scene graph nodes and other entities. Components can be attached to or removed from such scene graph nodes. Components can be used to activate or turn off behaviors, and/or correspond to state information associated with the specific scene graph node (see, e.g., “COMPONENTS (SCENE DATA)” section of the GLOSSARY for more detail). Component updates include transform updates, material property changes, collision and motion state associated with graphical content and so forth.

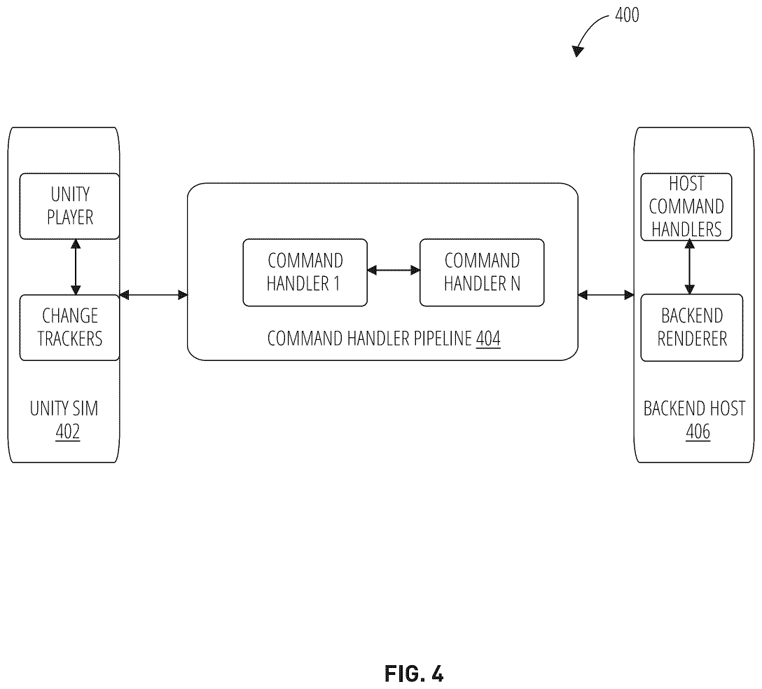

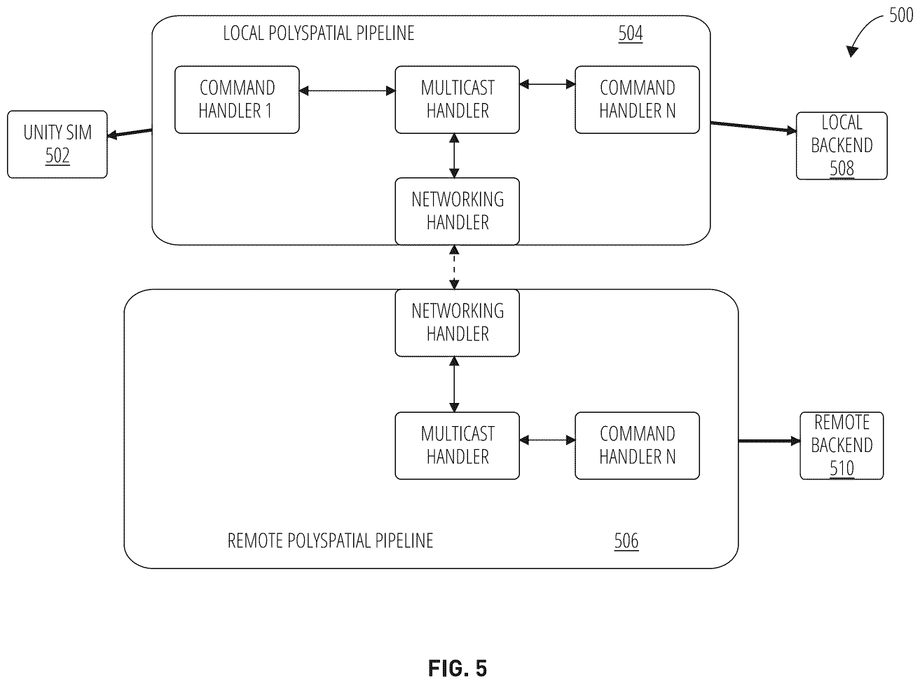

In some embodiments, the application (e.g., Universal Server Host App) integrates with a platform (e.g., UniversalServerHostPlatform) that can run on device or in editor, in play mode or in edit mode. UniversalServerHostPlatform examples include UnityEditorPlatform, a UnityPlayerPlatform, a UnityShellPlatform, a UnityUniversalServerHostNativePlatform, and so forth. A UniversalServerHostPlatform can back or integrate representations (e.g., command representations, scene representations), for example by integrating updates to assets or components into a native scene graph (e.g., collision information can be added into a scene graph with respect to relevant game objects). Alternative asset and/or command transmission mechanisms (both local and over the network) are described at least in FIG. 4 and FIG. 5.

FIG. 4 is a diagrammatic representation 400 of a command pipeline as implemented by an application interaction system 200. In some embodiments, the application interaction system 200 uses CommandHandler operators to handle the processing and/or transmission of commands (e.g., scene graph commands, input commands, and so forth, as described at least in FIG. 2)—for example, FIG. 4 illustrates command handler pipeline 404 connecting a Unity sim 402 and a backend host 406. In some embodiments, hosts and/or simulations (sims) are themselves command handlers as well. Thus, a host and/or a sim can be a terminal node and/or an intermediate node in an operator graph (further described below). The application interaction system 200 thus allows for arbitrary chaining of hosts, simulations and/or intermediate command handler nodes, which leads to a modular, flexible and/or extensible architecture. Each CommandHandler is a self-contained operator that receives one or more change lists or commands, performs operations on the change lists or commands, and then forwards them to the next command handler of a set of command handlers. CommandHandler operators can be connected in stages and/or pipelines of pre-determined, arbitrary and/or dynamically determined sizes and/or configurations. In some embodiments, CommandHandler operators can be assembled into an arbitrary or dynamically constructed graph to perform complex operations. Graph topology can vary based on use case, be automatically adjusted by adding and/or removing operators, and so forth.

An example CommandHandler can filter out commands, modify command data, inject new command, multiplex commands (e.g., branch data and/or send it to multiple receivers), remap IDs, append debugging information, perform compression/decompression, perform caching, transmit data, and so forth. Transmitting data can refer to sending in-memory data over the network via a socket, or receiving network data from a socket and convert to in-memory data (see, e.g., FIG. 5).

In some embodiments, the application interaction system 200 uses an ICommandHandler interface and a IHostCommandHandler interface from which two endpoints can be derived. For example, the system can then derive PolySpatialUnitySimulation (e.g., similar in some respects to HostNetworkPlatform) and, respectively, PolySpatialNetworkSingleAppHost/PolySpatialNetworkMultiAppHost (e.g., similar in some respects to ClientNetworkPlatform). The application interaction system 200 can accommodate an arbitrary graph of command handlers in between two endpoints to perform various operations. Thus, the system enables developers to build functionality in isolation, and/or provide a set of interacting (e.g., chained, etc.) operators assembled into complex graphs that perform complex operations.

FIG. 5 is a diagrammatic representation 500 of a networked pipeline as implemented by an application interaction system 200. In some embodiments, the application interaction system 200 implements a networking solution that relies on individual CommandHandler operators. As mentioned in FIG. 4, CommandHandler operators can be connected in stages and/or pipelines—furthermore, pipelines can be connected over the network. Thus, CommandHandler operators can be chained, combined and/or assembled to perform complex operations. FIG. 5 illustrates local polyspatial pipeline 504 and a remote polyspatial pipeline 506. FIG. 5 illustrates CommandHandler operators connected and/or chained, for example via multicast handlers and network handlers. The illustrated pipelines enable an application simulation (e.g, a Unity sim 502) to communicate with a local backend 508 and/or a remote backend 510.

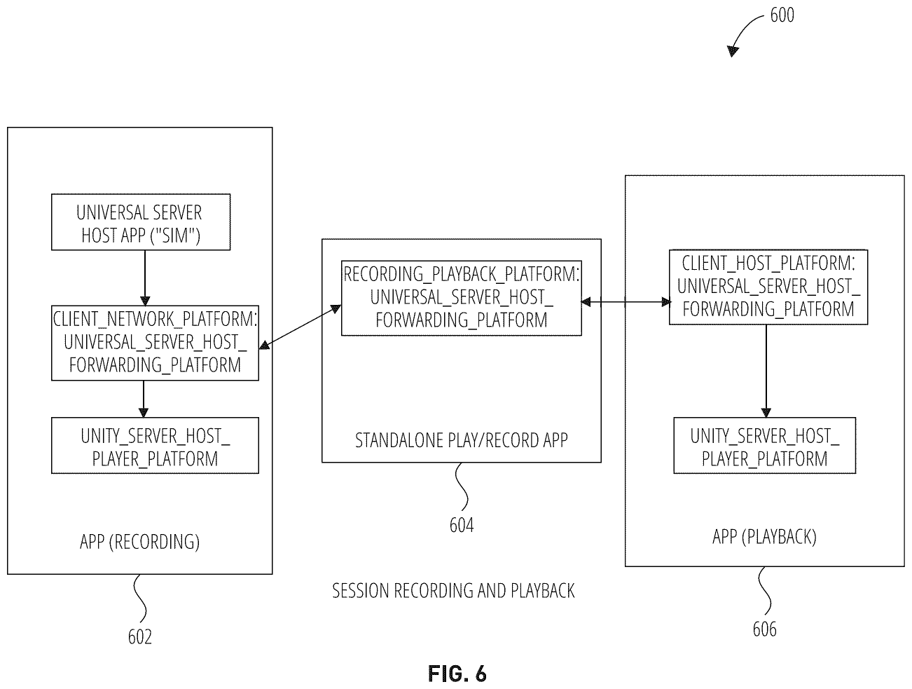

FIG. 6 is a diagrammatic representation 600 of a view of an application interaction system 200, according to some embodiments. FIG. 6 illustrates an example implementation of a session recording and playback capability for a game session (such as a Unity game session). In some embodiments, a standalone play/record application 604 operates as a host for a recording application 602 and a playback application 606.

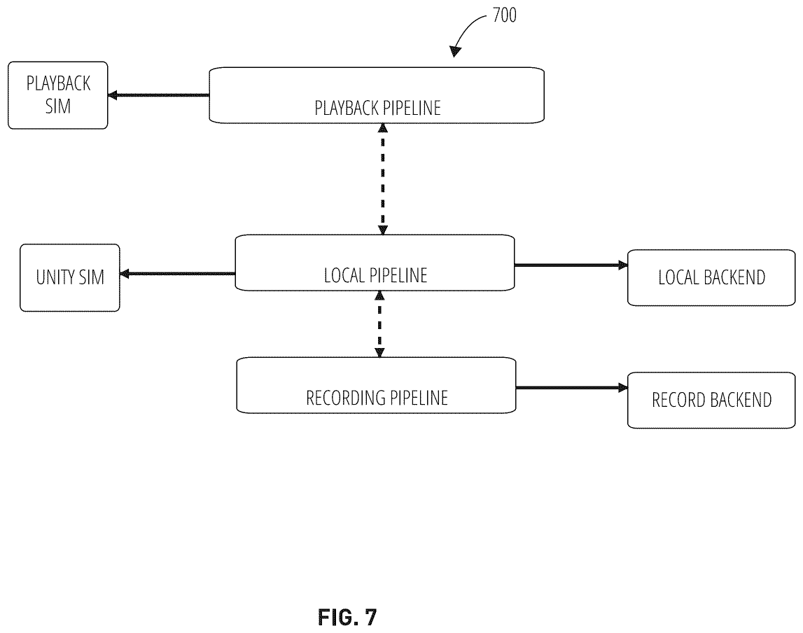

FIG. 7 is a diagrammatic representation 700 of a view of an application interaction system 200, according to some embodiments. FIG. 7 illustrates an alternative implementation of a session recording and playback capability for a game session (e.g., a Unity game session), where communication among applications and/or between applications and respective backends is implemented via command handler pipelines, as described at least in FIG. 4 and FIG. 5.

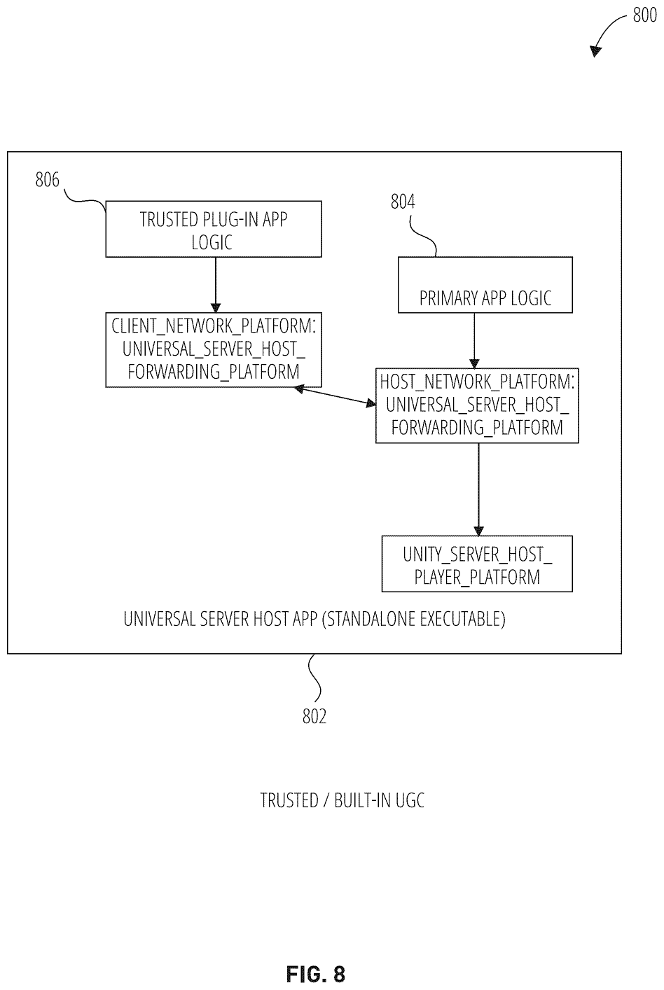

FIG. 8 is a diagrammatic representation 800 of a view of an application interaction system 200, according to some embodiments. In this example, an app with primary app logic 804 operates as a host for a plugin app (here, a trusted or built-in plugin) with corresponding internal plugin app logic 806. The application interaction system 200 enables fully featured, sandboxed plugins, such as for example user-generated content (UGC) apps, that can run within other applications. In some embodiments, such full-feature plugins include chat apps, streaming tools, minigames, fully-playable ads, achievement systems, and so forth. Such plugins can enable interactive or fully playable ads (or demos) that can increase engagement and/or help differentiate in-game ads from more static media, such as video, image, or text-based ads. Such plugins could be dramatically useful in increasing ad market reach (e.g., for Unity ads).

As show in FIG. 8, plugins can run within other applications (e.g., within the standalone executable with primary app logic 804). Such container or host applications can include social VR applications (VR Chat, Recroom, Altspace, etc.), which provide ways for users to develop custom content, but must mitigate issues such as version mismatching or security concerns. Sandboxing applications in their own process (while enabling them to connect, for example via local sockets) delegates responsibilities like system source management and security to the underlying operating system (OS). Therefore, application interaction system 200 can provide a generalized framework for integrating user-generated content (UGC) that supports arbitrarily complex user-created content which is safe to run via OS-level sandboxing. Furthermore, the application interaction system 200 enables developing a game plugin once and running it within one or more applications (such as for example Unity game applications).

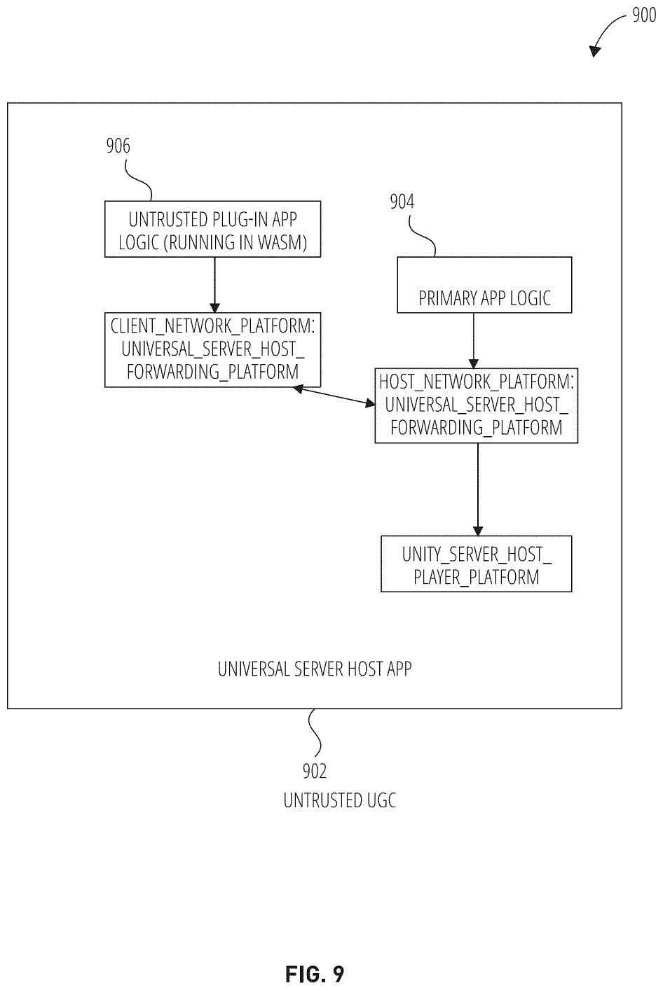

FIG. 9 is a diagrammatic representation 900 of a view of an application interaction system 200, according to some embodiments. In this example, a standalone or primary app with primary app logic 904 operates as a host app for a plugin app (here, an untrusted plugin) with corresponding internal plugin app logic 906. Such untrusted plugins can correspond to content generated by users which is not built-in to the primary app. In some embodiments, the untrusted plugin app is associated with a portable binary code format (e.g., Web Assembly (WASM), etc.). As mentioned in the description to FIG. 8, sandboxing applications in their own process (while enabling them to connect, for example via local sockets) delegates responsibilities like system source management and security to the underlying operating system (OS), and allows the system to run user-created content in a safe manner.

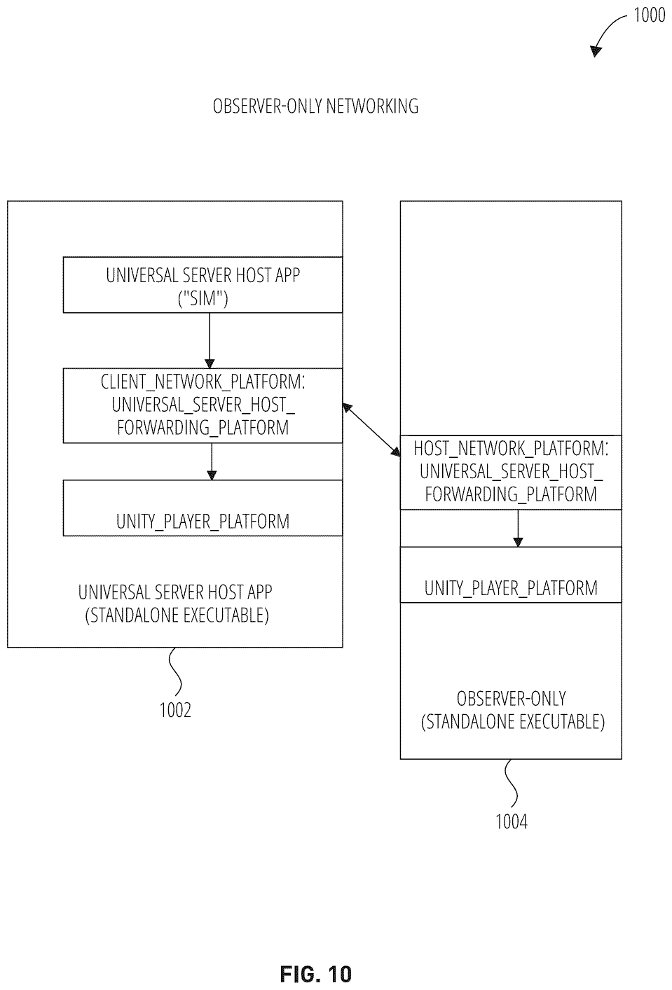

FIG. 10 is a diagrammatic representation 1000 of a view of an application interaction system 200, according to some embodiments. In this example, a standalone app 1002 (e.g., a game or application game such as a Unity game or application), can have a corresponding observer-only host in the form of an observer-only standalone app 1004. In some embodiments, a user can employ such observer-only standalone executables to stream games or other applications being played or running on Twitch, another similar streaming service, or any platform providing built-in facilities for “observer-only” clients for games.

In some embodiments, the communication between the application adhering to the universal server specification and the application adhering to the universal host specification is achieved using a ClientNetworkPlatform and a HostNetworkPlatform. In some embodiments, a ClientNetworkPlatform can run on device or in editor. Similarly, a HostNetworkPlatform runs in editor or on device. Alternative communication mechanisms are described at least in FIG. 4 and FIG. 5.

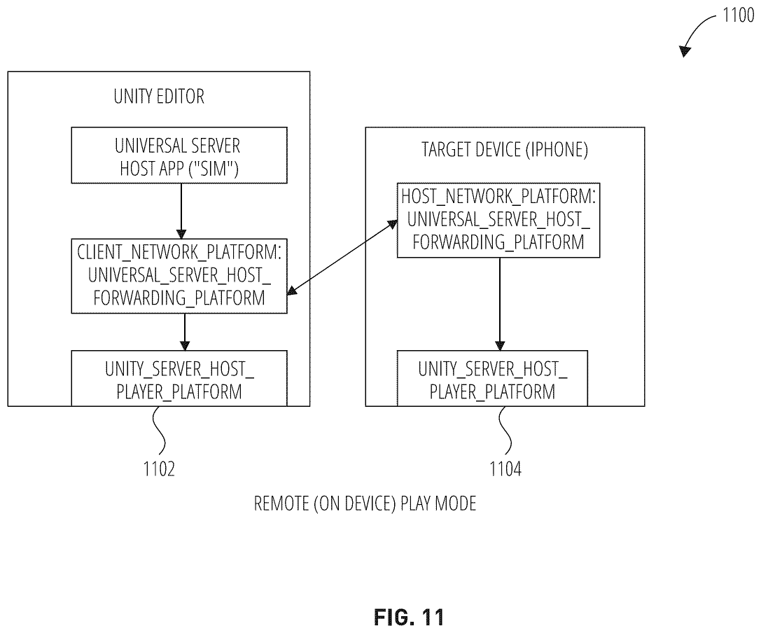

FIG. 11 is a diagrammatic representation 1100 of a view of an application interaction system 200, according to some embodiments. FIG. 11 illustrates an application 1102 running in editor that implements the universal server specification (e.g., an app such as a Unity game or application) and interacts with a host application 1104 on a target device (e.g., an iPhone). In some embodiments, the target device host is associated with a “universal player” platform (e.g., UnityPlayerPlatform); for example, once a universal player has been installed on the target device and can communicate with a universal server-adhering application, (such as the above-mentioned app), a user of the device can remotely play any such compatible application.

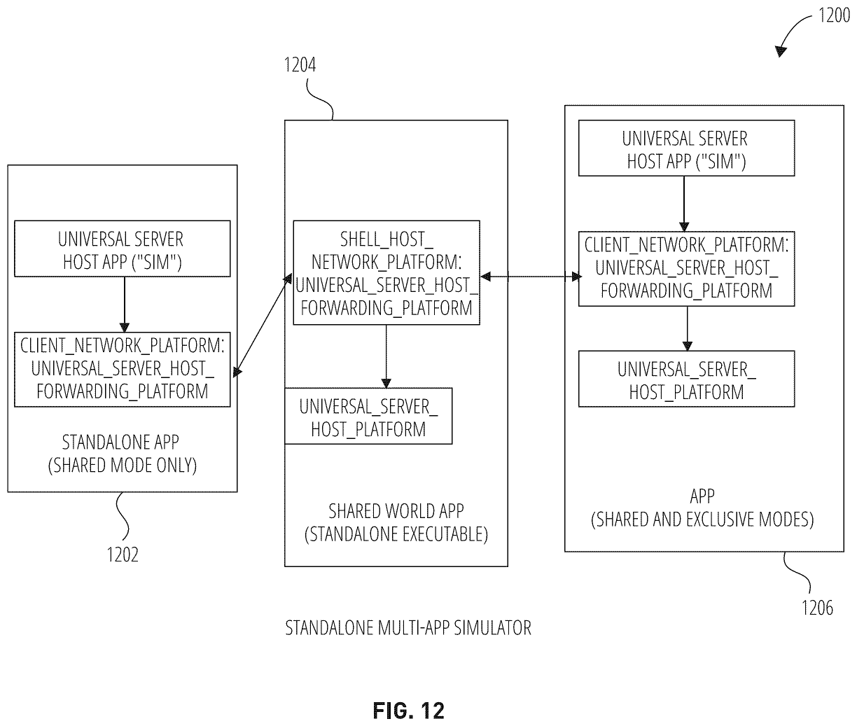

FIG. 12 is a diagrammatic representation of a view 1200 of an application interaction system 200. In some embodiments, the application interaction system 200 can enable a “white-box” shared world solution, in the form of a generalized shell upon which shared world operating systems or OS-features can be built. For example, an AR headset developer may want to provide OS-level features for displaying many applications simultaneously on top of the real world.

In some embodiments, a shared world app 1204 can function as a host for a first app 1202 (e.g., a standalone Universal Server-Host App in shared mode) and a second app 1206 (e.g., a Universal Server-Host App in shared and/or exclusive modes). Thus, the application interaction system 200 enables implementing a standalone multi-application simulator.

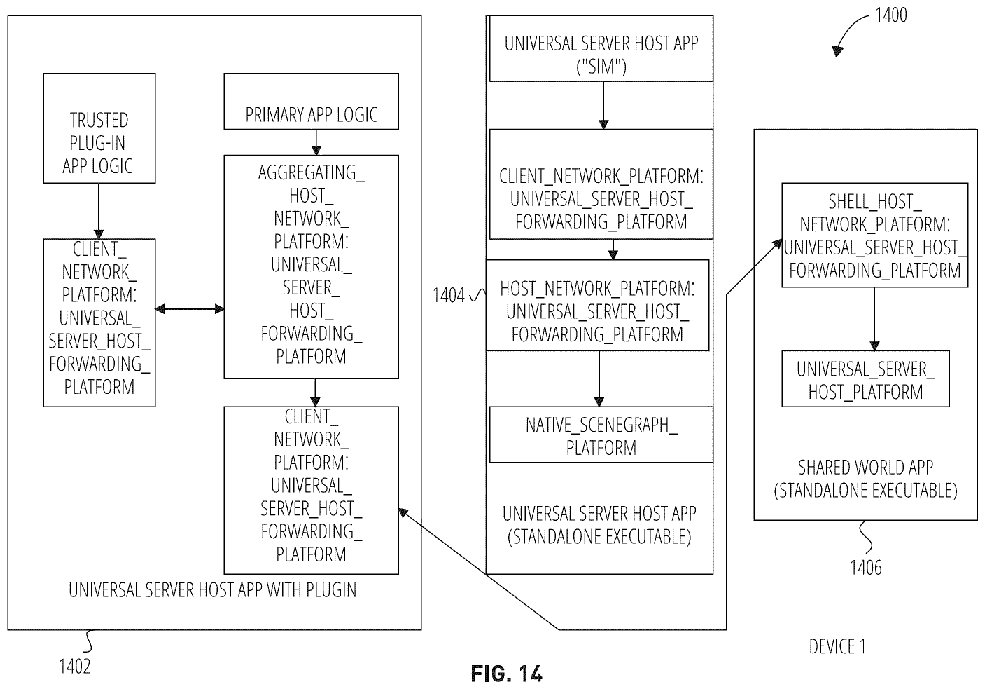

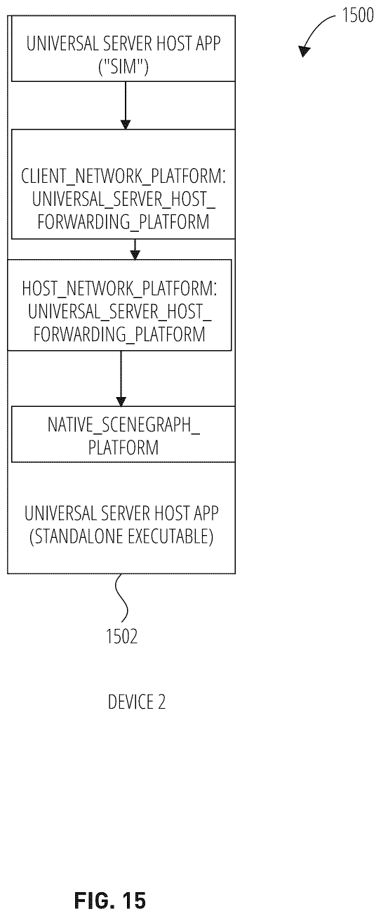

FIG. 13 is a diagrammatic representation of a view 1300 of an application interaction system 200. In some embodiments, the application interaction system 200 enables software programs to become software platforms that can host other applications in a recursive manner. An application can therefore host third party plugins. FIG. 13-FIG. 15 illustrate a networked setup involving multiple applications on multiple devices (e.g., see Device 1 1302, Device 2 1306 in FIG. 14 and FIG. 15) and a dedicated server (see, e.g., 1304).

FIG. 14 is a diagrammatic representation 1400 of a view of an application interaction system 200, according to some embodiments. In some embodiments, the application interaction system 200, in conjunction with a multispatial (or polyspatial) graph capability, enables software programs to become software platforms that host other applications in a recursive manner. Thus, an application can host third party plugins.

FIG. 14 showcases a first device (Device 1) with corresponding applications 1402, 1404 and 1406, the first application 1402 hosting a third party trusted plugin application. In some embodiments, the first application 1402 itself can be hosted within a shared world shell 1406 (e.g,, Shared World App). The shared world shell 1406 allows for simultaneous interaction of multiple applications (e.g., Universal Server-Host App with Plugin, Universal Server-Host App on dedicated server, as seen in FIG. 13), as part of a networked setup involving multiple users and/or devices (see, e.g., FIG. 13-FIG. 15).

FIG. 15 is a diagrammatic representation 1500 of a view of an application interaction system 200, according to some embodiments. FIG. 15 illustrates a host application 1502 running on Device 2, the application being part of the networked setup described in FIG. 13-FIG. 15. In some embodiments, the host application 1502 corresponds to an instance of the same application running on Device 1 in FIG. 13. Thus, in some embodiments, multiple applications (e.g, “Universal Server-Host App” on Device 1 in FIG. 14, “Universal Server-Host App” on Device 2 in FIG. 15, etc.) operate as clients in conjunction with a dedicated server (e.g., see “Universal Server-Host App” on the dedicated server in FIG. 13).

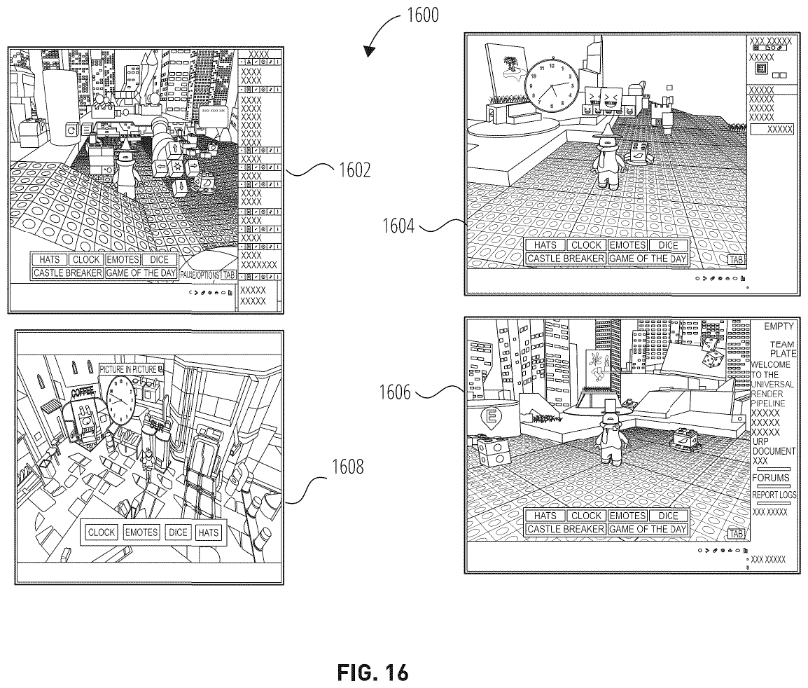

FIG. 16 is an illustration 1600 of several views of an application interaction system 200, according to some embodiments. Views 1602, 1604 and 1606 illustrate a shared “Lego” world that functions as a host for user-generated content and applications. For example, Hats, Clock, Emotes, Dice, CastleBreaker and Game of the Day are separate applications (apps), connected to or running inside the Lego host application. Each mini-application is run in a separate process for security sandboxing reasons, but interacts with the host application as part of the application interaction system 200 as enabled by the polyspatial graph.

As noted in views 1602, 1604, or 1606, the character can exhibit a different hat (as enabled by the Hats mini-app), the clock and dice can be visible in the screen space (e.g., as enabled by the Clock and Dice mini-apps), the emotes function as a 3D user interface (UI) as per the Emotes app, and the castle breaker refers to a fully embedded and playable game. A related element, the “game of the day,” not shown, refers to a rolling lego ball which acts as a piece of modal content. Once developed, a UGC plugin or a mini-application can run inside more than one host application. For example, view 1608 highlights the clock in a screen space corresponding to a different shell world application.

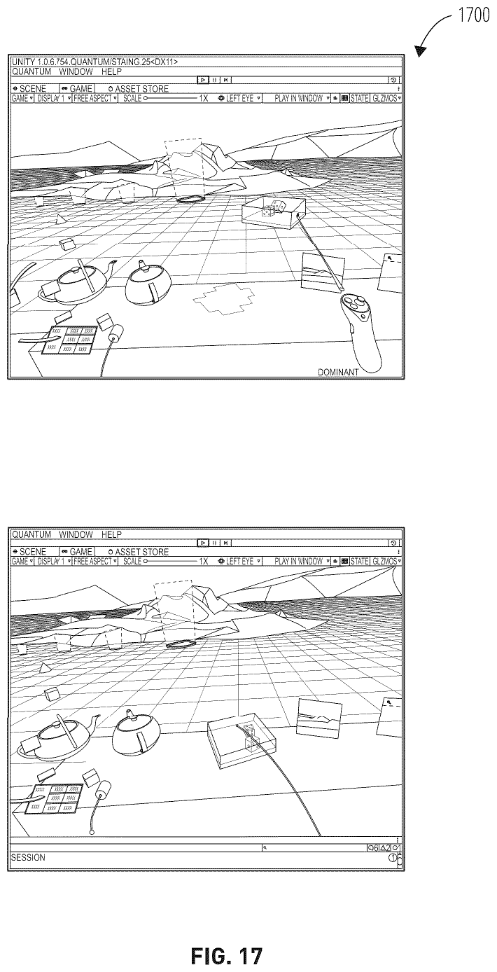

FIG. 17 is an illustration 1700 of several views of an application interaction system 200, according to some embodiments. In some embodiments, as described in relation to FIG. 2, applications are assigned one or more dedicated volumes and/or windows, which they control. Such volumes and/or windows can be moved and/or resized. Here, a dice app runs in a XR Design Framework bounding box manipulator. The volume corresponding to the dice app is movable, as well as resizable, and the dice app runs inside a host world application.

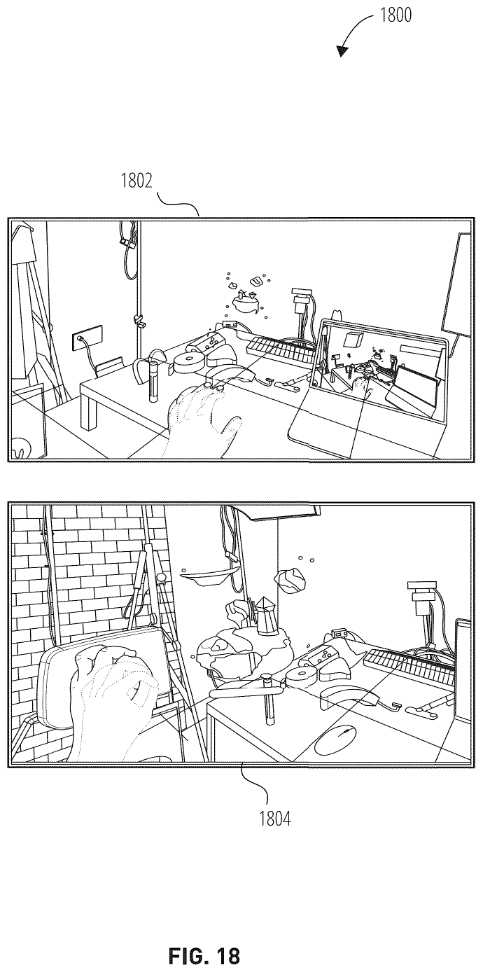

FIG. 18 is an illustration 1800 of several views of an application interaction system 200, according to some embodiments. As described in at least FIG. 2 and FIG. 17, applications are assigned one or more dedicated volumes and/or windows, which can be moved and/or resized. A user can interact with such volumes and corresponding applications. FIG. 18 illustrates a user's interaction with a volume corresponding to an application, an interaction which results in moving the volume (see view 1802) and resizing the volume (see view 1804).

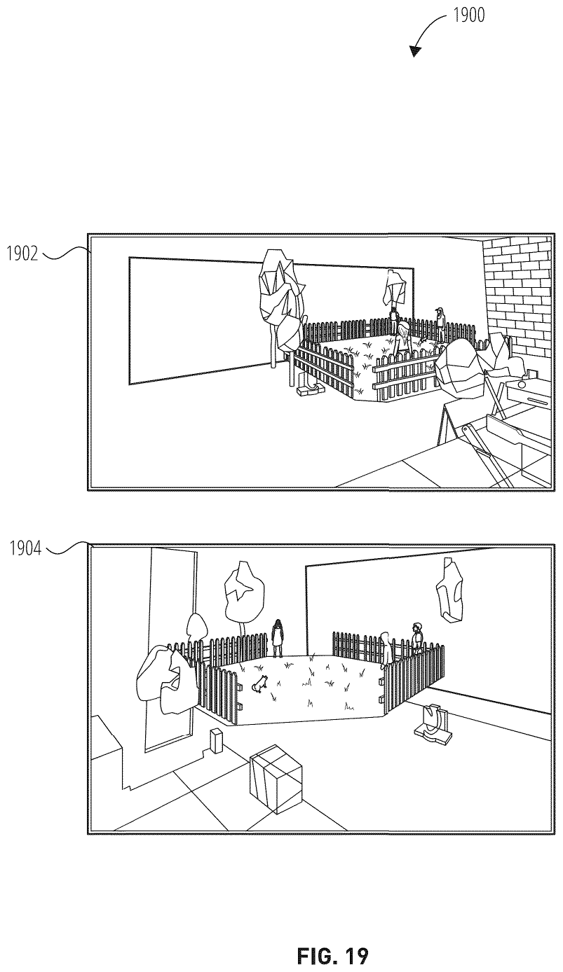

FIG. 19 is an illustration 1900 of several views of an application interaction system 200, according to some embodiments. As described in at least FIG. 2 and FIG. 17, applications are assigned one or more dedicated volumes and/or windows, which can be moved and/or resized. A user may otherwise interact with such volumes, windows and/or corresponding apps. The succession of view 1902 and view 1904, two example views from a longer view sequence, illustrates live updates for an application associated with a movable, resizable volume. For example, as can be seen in 1904, the application changes include movement of the characters and/or objects in the scene. The succession of views illustrates how the simulation logic unfolds, resulting in changes to the appearance and location of the scene graph objects. A user can move the entire volume, and/or resize the corresponding volume associated with the application, while the application simulation continues within the respective volume.

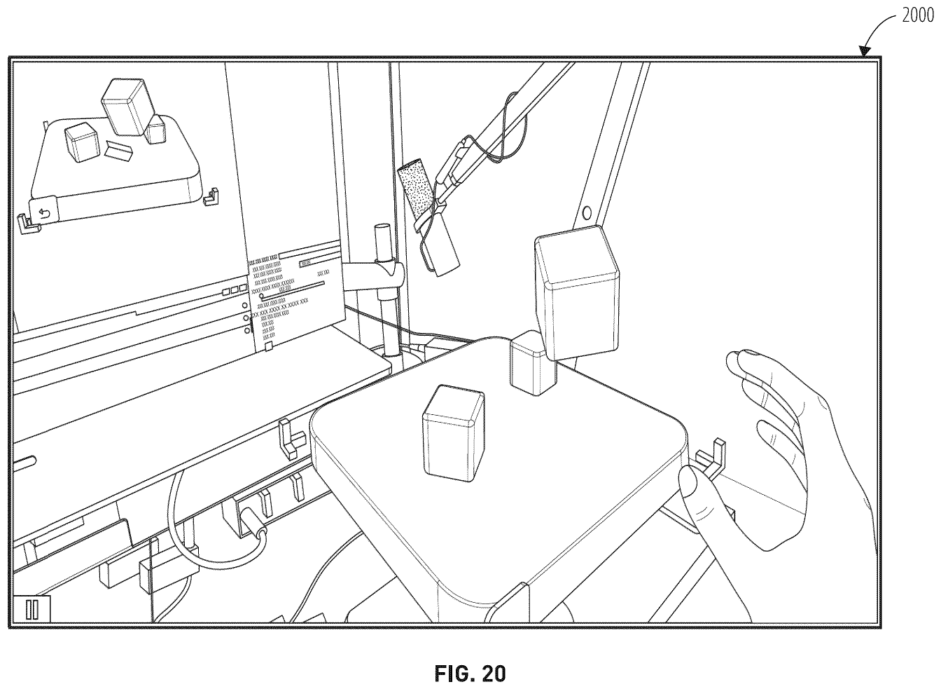

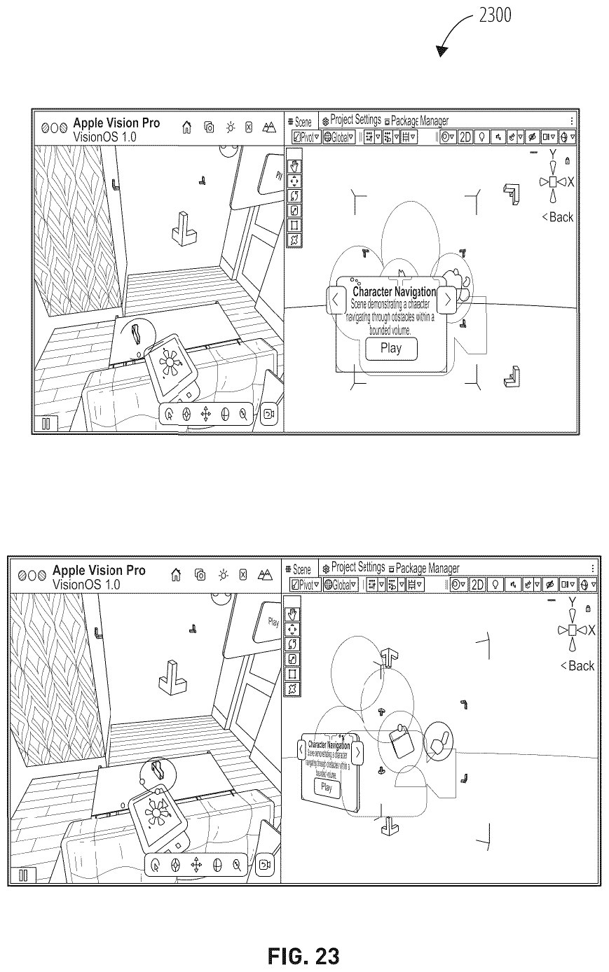

FIG. 20 is an illustration 2000 of a view of an application interaction system 200, according to some embodiments. In some embodiments, application interaction system 200 can enable a play-to-device capability that allows the synchronization of content changes made by a developer and/or user (e.g., in an editor application such as Unity Editor) to a simulator and/or device. Conversely, interactions performed on the device and/or host are synchronized back to the editor application. Content changes can include creating game objects, updating and/or recompiling shader graphs, and so forth. Content change and/or content interaction synchronization significantly improves iteration and/or debugging operations. The capability above can be implemented via a “Play to Device Host” application, installed, on a device (e.g., the visionOS Simulator, an Apple Vision Pro device, etc.), as further seen in FIG. 23.

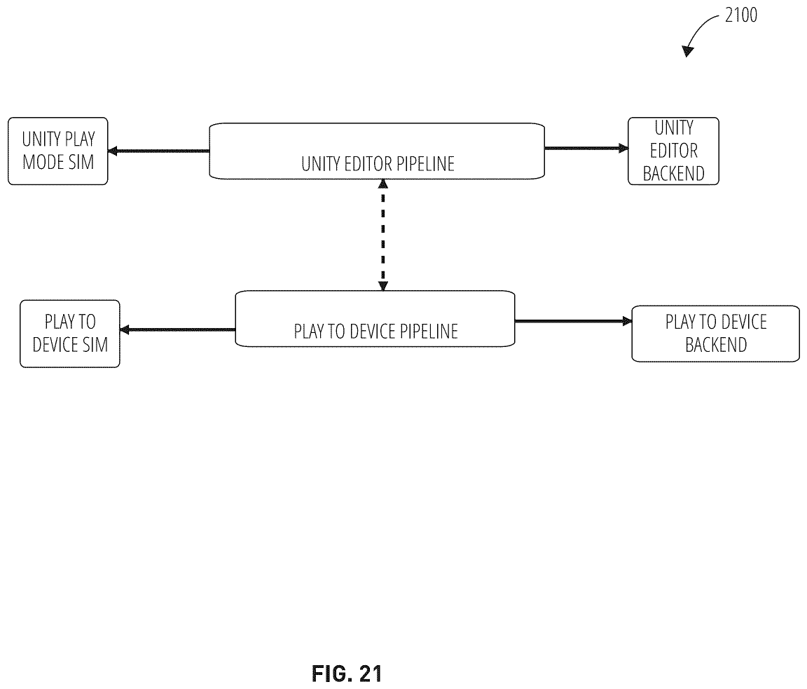

FIG. 21 is an illustration 2100 of a view of an application interaction system 200, according to some embodiments. FIG. 21 illustrates an example implementation for the content change and/or interaction synchronization capability in FIG. 20. A Play to Device simulation (e.g., corresponding to a Play to Device Host application), running on a corresponding backend, communicates with a Unity Play Mode simulation in Unity Editor running on a Unity Editor backend. The Play to Device pipeline and Unity Editor pipeline are, in some embodiments, instantiations of command pipelines as detailed in FIG. 4 and FIG. 5.

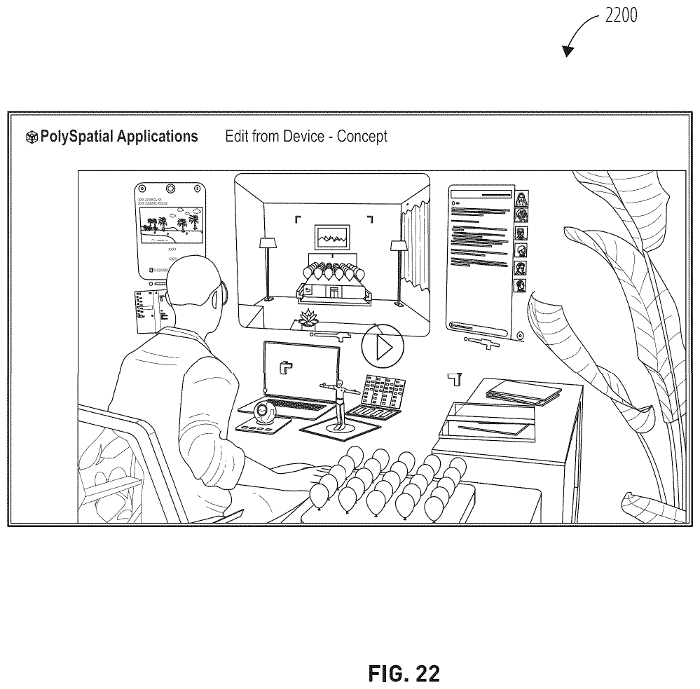

FIG. 22 and FIG. 23 are illustrations 2200 and 2300 of views of an application interaction system 200, according to some embodiments. FIG. 22 and FIG. 23 further illustrate the application interaction system 200 synchronizing content edits, via a device, with an editor application.

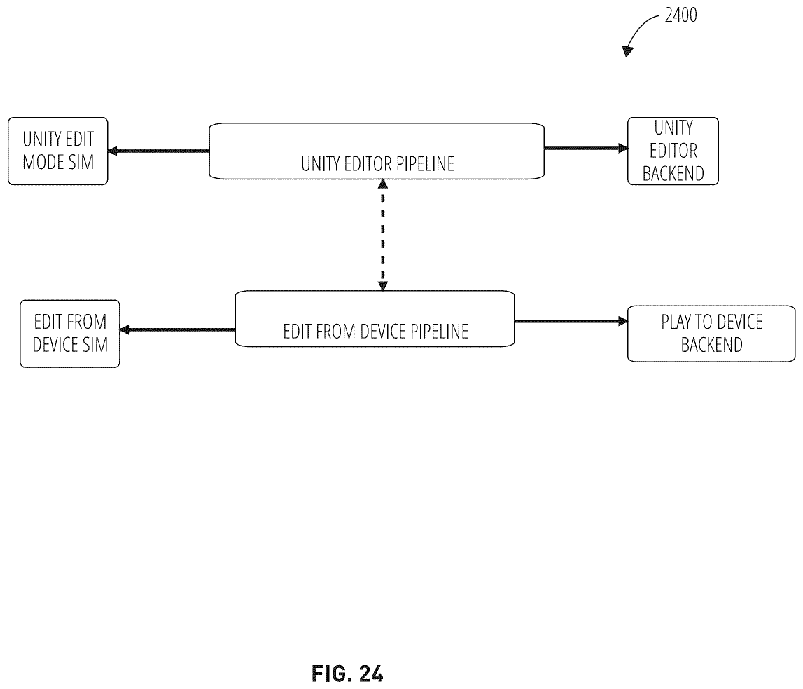

FIG. 24 is a diagrammatic representation of a view of an application interaction system, according to some embodiments. FIG. 24 illustrates an example implementation for the content edit synchronization capability referred to by FIG. 22 and/or FIG. 23. In some embodiments, the capability is implemented using an Edit from Device simulation on a corresponding backend (e.g., a Play to Device backend) communicating with a Unity Edit Mode simulation on a Unity Editor backend. The Edit from Device pipeline and Unity Editor pipeline are, in some embodiments, instantiations of command pipelines as detailed in FIG. 4 and FIG. 5.

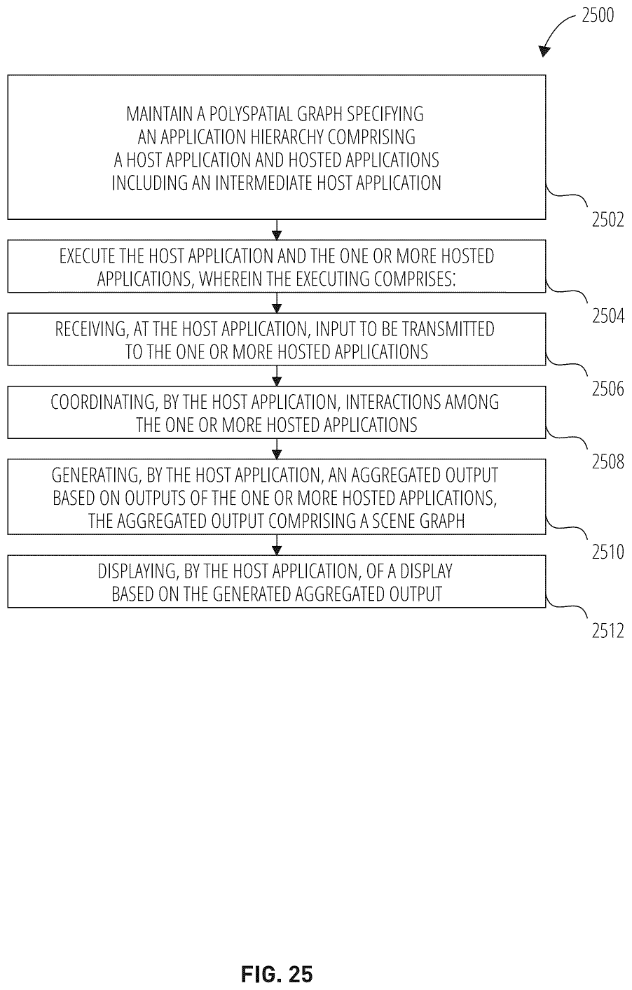

FIG. 25 is a flowchart illustrating a method 2500 implemented by the application interaction system 200, according to some embodiments. The application interaction system 200 maintains, at a computing device, a polyspatial graph specifying an application hierarchy comprising at least a host application, and one or more hosted applications to be executed within the host application, one of the one or more hosted applications corresponding to an intermediate host application for an additional application (see operation 2502). The application interaction system 200 executes the host application and the one or more hosted applications (operation 2504), the executing comprising: receiving, at the host application, input to be transmitted to the one or more hosted applications (operation 2506), coordinating, by the host application, interactions among the one or more hosted applications (operation 2508), generating, by the host application, of an aggregated output based on outputs of the one or more hosted applications, the aggregated output comprising a scene graph (operation 2510). At operation 2512, the application interaction system 200 further enables displaying, by the host application at the computing device, of a display based on the generated aggregated output.

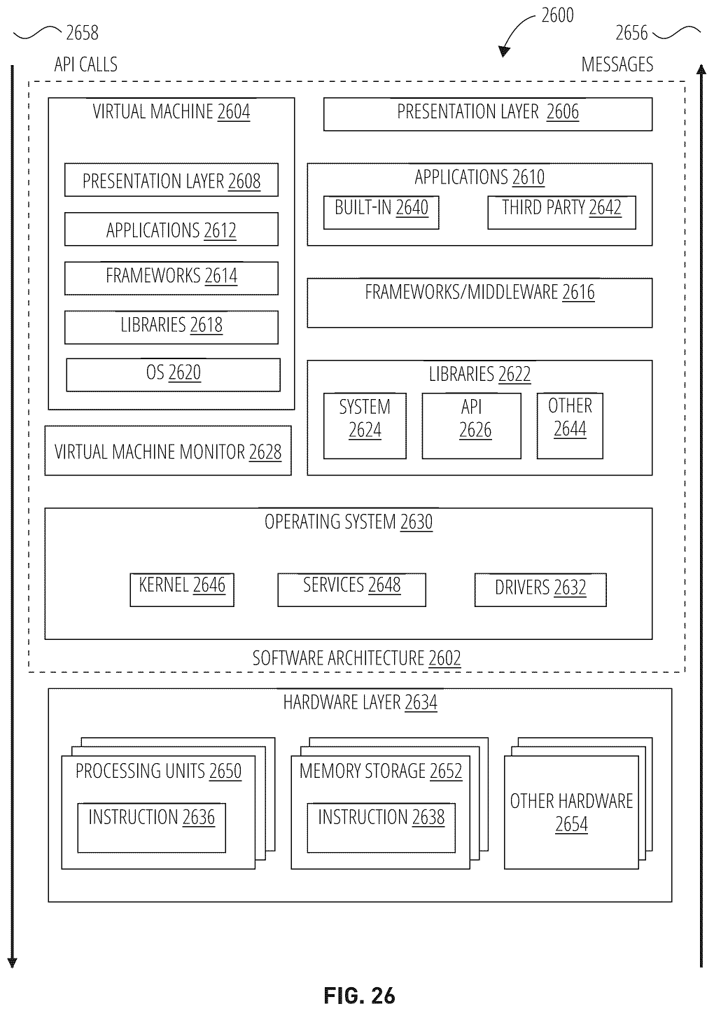

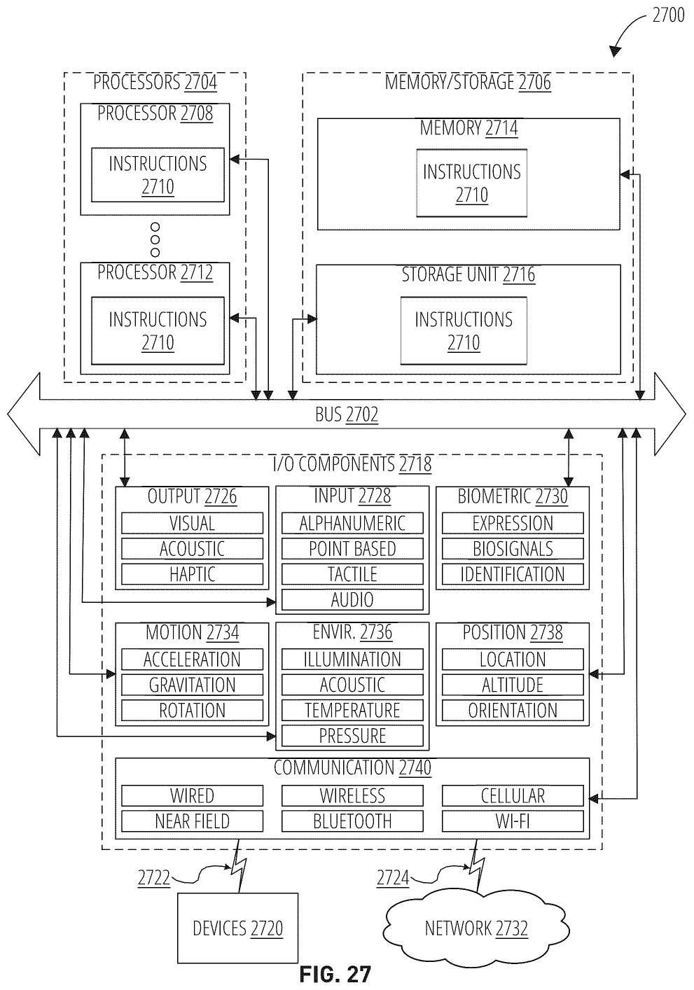

FIG. 26 is a block diagram illustrating an example of a software architecture 2602 that may be installed on a machine, according to some example embodiments. FIG. 26 is merely a non-limiting example of software architecture, and it will be appreciated that many other architectures may be implemented to facilitate the functionality described herein. The software architecture 2602 may be executing on hardware such as a machine 2700 of FIG. 27 that includes, among other things, processors 2704, memory/storage 2706, and input/output (I/O) components 2718. A representative hardware layer 2634 is illustrated and can represent, for example, the machine of FIG. 27. The representative hardware layer 2634 comprises one or more processing units 2650 having associated executable instructions 2636. The executable instructions 2636 represent the executable instructions of the software architecture 2602. The hardware layer 2634 also includes memory or memory storage 2652, which also have the executable instructions 2638. The hardware layer 2634 may also comprise other hardware 2654, which represents any other hardware of the hardware layer 2634 such as the other hardware illustrated as part of the machine 2700.

In the example architecture of FIG. 26, the software architecture 2602 may be conceptualized as a stack of layers, where each layer provides particular functionality. For example, the software architecture 2602 may include layers such as an operating system 2630, libraries 2618, frameworks/middleware 2616, applications 2610, and a presentation layer 2608. Operationally, the applications 2610 or other components within the layers may invoke API calls 2658 through the software stack and receive a response, returned values, and so forth (illustrated as messages 2656) in response to the API calls 2658. The layers illustrated are representative in nature, and not all software architectures have all layers. For example, some mobile or special-purpose operating systems may not provide a frameworks/middleware 2616 layer, while others may provide such a layer. Other software architectures may include additional or different layers.

The operating system 2630 may manage hardware resources and provide common services. The operating system 2630 may include, for example, a kernel 2646, services 2648, and drivers 2632. The kernel 2646 may act as an abstraction layer between the hardware and the other software layers. For example, the kernel 2646 may be responsible for memory management, processor management (e.g., scheduling), component management, networking, security settings, and so on. The services 2648 may provide other common services for the other software layers. The drivers 2632 may be responsible for controlling or interfacing with the underlying hardware. For instance, the drivers 2632 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 2618 may provide a common infrastructure that may be utilized by the applications 2610 and/or other components and/or layers. The libraries 2618 or 2622 typically provide functionality that allows other software modules to perform tasks in an easier fashion than by interfacing directly with the underlying operating system 2630 functionality (e.g., kernel 2646, services 2648 or drivers 2632). The libraries 2618 or 2622 may include system libraries 2624 (e.g., C standard library) that may provide functions such as memory allocation functions, string manipulation functions, mathematic functions, and the like. In addition, the libraries 2618 or 2622 may include API libraries 2626 such as media libraries (e.g., libraries to support presentation and manipulation of various media formats such as MPEG4, H.264, MP3, AAC, AMR, JPG, and PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 2618 or 2622 may also include a wide variety of other libraries 2644 to provide many other APIs to the applications 2610 or applications 2612 and other software components/modules.

The frameworks 2614 (also sometimes referred to as middleware) may provide a higher-level common infrastructure that may be utilized by the applications 2610 or other software components/modules. For example, the frameworks 2614 may provide various graphical user interface functions, high-level resource management, high-level location services, and so forth. The frameworks 2614 may provide a broad spectrum of other APIs that may be utilized by the applications 2610 and/or other software components/modules, some of which may be specific to a particular operating system or platform.

The applications 2610 include built-in applications 2640 and/or third-party applications 2642. Examples of representative built-in applications 2640 may include, but are not limited to, a home application, a contacts application, a browser application, a book reader application, a location application, a media application, a messaging application, or a game application.

The third-party applications 2642 may include any of the built-in applications 2640 as well as a broad assortment of other applications. In a specific example, the third-party applications 2642 (e.g., an application developed using the Android™ or iOS™ software development kit (SDK) by an entity other than the vendor of the particular platform) may be mobile software running on a mobile operating system such as iOS™, Android™, or other mobile operating systems. In this example, the third-party applications 2642 may invoke the API calls 2658 provided by the mobile operating system such as the operating system 2630 to facilitate functionality described herein.

The applications 2610 may utilize built-in operating system functions, libraries (e.g., system libraries 2624, API libraries 2626, and other libraries), or frameworks/middleware 2616 to create user interfaces to interact with users of the system. Alternatively, or additionally, in some systems, interactions with a user may occur through a presentation layer, such as the presentation layer 2608. In these systems, the application/module “logic” can be separated from the aspects of the application/module that interact with the user.

Some software architectures utilize virtual machines. In the example of FIG. 26, this is illustrated by a virtual machine 2604. The virtual machine 2604 creates a software environment where applications/modules can execute as if they were executing on a hardware machine. The virtual machine 2604 is hosted by a host operating system (e.g., the operating system 2630) and typically, although not always, has a virtual machine monitor 2628, which manages the operation of the virtual machine 2604 as well as the interface with the host operating system (e.g., the operating system 2630). A software architecture executes within the virtual machine 2604, such as an operating system 2630, libraries 2618, frameworks/middleware 2616, applications 2612, or a presentation layer 2608. These layers of software architecture executing within the virtual machine 2604 can be the same as corresponding layers previously described or may be different.

FIG. 27 is a block diagram illustrating components of a machine 2700, according to some example embodiments, able to read instructions from a machine-readable medium (e.g., a machine-readable storage medium) and perform any one or more of the methodologies discussed herein. Specifically, FIG. 27 shows a diagrammatic representation of the machine 2700 in the example form of a computer system, within which instructions 2710 (e.g., software, a program, an application, an applet, an app, or other executable code) for causing the machine 2700 to perform any one or more of the methodologies discussed herein may be executed. As such, the instructions 2710 may be used to implement modules or components described herein. The instructions 2710 transform the general, non-programmed machine 2700 into a particular machine 2700 to carry out the described and illustrated functions in the manner described. In alternative embodiments, the machine 2700 operates as a standalone device or may be coupled (e.g., networked) to other machines. In a networked deployment, the machine 2700 may operate in the capacity of a server machine or a client machine in a server-client network environment, or as a peer machine in a peer-to-peer (or distributed) network environment. The machine 2700 may comprise, but not be limited to, a server computer, a client computer, a personal computer (PC), a tablet computer, a laptop computer, a netbook, a personal digital assistant (PDA), an entertainment media system, a cellular telephone, a smart phone, a mobile device, a wearable device (e.g., a smart watch), other smart devices, a web appliance, a network router, a network switch, a network bridge, or any machine capable of executing the instructions 2710, sequentially or otherwise, that specify actions to be taken by machine 2700. Further, while only a single machine 2700 is illustrated, the term “machine” shall also be taken to include a collection of machines that individually or jointly execute the instructions 2710 to perform any one or more of the methodologies discussed herein.

The machine 2700 may include processors 2704, memory/storage 2706, and I/O components 2718, which may be configured to communicate with each other such as via a bus 2702. The memory/storage 2706 may include a memory 2714, such as a main memory, or other memory storage, and a storage unit 2716, both accessible to the processors 2704 such as via the bus 2702. The storage unit 2716 and memory 2714 store the instructions 2710 embodying any one or more of the methodologies or functions described herein. The instructions 2710 may also reside, completely or partially, within the memory 2714 within the storage unit 2716, within at least one of the processors 2704 (e.g., within the processor's cache memory), or any suitable combination thereof, during execution thereof by the machine 2700. Accordingly, the memory 2714 the storage unit 2716, and the memory of processors 2704 are examples of machine-readable media.

The I/O components 2718 may include a wide variety of components to receive input, provide output, produce output, transmit information, exchange information, capture measurements, and so on. The specific I/O components 2718 that are included in a particular machine 2700 will depend on the type of machine. For example, portable machines such as mobile phones will likely include a touch input device or other such input mechanisms, while a headless server machine will likely not include such a touch input device. It will be appreciated that the I/O components 2718 may include many other components that are not shown in FIG. 11. The I/O components 2718 are grouped according to functionality merely for simplifying the following discussion and the grouping is in no way limiting. In various example embodiments, the I/O components 2718 may include output components 2726 and input components 2728. The output components 2726 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 2728 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 2718 may include biometric components 2730, motion components 2734, environmental environment components 2736, or position components 2738 among a wide array of other components. For example, the biometric components 830 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 2734 may include acceleration sensor components (e.g., accelerometer), gravitation sensor components, rotation sensor components (e.g., gyroscope), and so forth. The environment components 2736 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 2738 may include location sensor components (e.g., a Global Position system (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 2718 may include communication components 2740 operable to couple the machine 2700 to a network 2732 or devices 2720 via coupling 2722 and coupling 2724 respectively. For example, the communication components 2740 may include a network interface component or other suitable device to interface with the network 2732. In further examples, communication components 2740 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 2720 may be another machine or any of a wide variety of peripheral devices (e.g., a peripheral device coupled via a Universal Serial Bus (USB)).

Moreover, the communication components 2740 may detect identifiers or include components operable to detect identifiers. For example, the communication components 2740 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 2740, such as, location via Internet Protocol (IP) geo-location, location via Wi-Fi® signal triangulation, location via detecting a NFC beacon signal that may indicate a particular location, and so forth.

### Example Embodiments

Embodiment 1 is a non-transitory computer-readable storage medium storing instructions that, when executed by at least one processor, cause the at least one processor to perform operations comprising: maintaining a polyspatial graph specifying an application hierarchy comprising at least a host application, one or more hosted applications to be executed within the host application, one of the one or more hosted applications corresponding to an intermediate host application for an additional application; and executing the host application and the one or more hosted applications, the executing comprising: receiving, at the host application, input to be transmitted to the one or more hosted applications; coordinating, by the host application, interactions among the one or more hosted applications; generating, by the host application, of an aggregated output based on outputs of the one or more hosted applications, the aggregated output comprising a scene graph; and displaying, by the host application, of a display based on the generated aggregated output.

In Embodiment 2, the subject matter of Embodiment 1 includes, wherein the application hierarchy further comprises the additional application to be executed within the intermediate host application, the executing comprising: receiving, at the intermediate host application, the input from the host application: transmitting, at the intermediate host application, the input to the additional application; receiving at the intermediate host application, output from the additional application; and transmitting, at the intermediate host application, the output from the additional application to the host application.

In Embodiment 3, the subject matter of Embodiments 1-2 includes, wherein: the host application and the one or more hosted applications share a logical 3D space; each hosted application of the one or more hosted applications controls a volume or window enabled to be moved, resized or change shape; and the coordinating, by the host application, of interactions among the one or more hosted applications comprises resolving conflicts among the hosted applications caused by volume overlaps in the logical 3D space for volumes or windows controlled by the hosted applications.

In Embodiment 4, the subject matter of Embodiment 3 includes, wherein an additional application is connected, over a network, to the host application or to one of the one or more hosted applications, the additional application sharing the logical 3D space or an additional 3D space associated with the logical 3D space.

In Embodiment 5, the subject matter of Embodiments 1-4 includes, wherein: an application of the one or more hosted applications is associated with content or state data; and upon detecting changes to the content or the state data wherein the changes comprise one or more of updates to assets, updates to properties of materials or updates to transformations, the application transmits the detected changes to at least the host application.

In Embodiment 6, the subject matter of Embodiments 1-5 includes, wherein generating, by the host application, of the aggregated output is further based on local content of the host application or a local user interface (UI).

In Embodiment 7, the subject matter of Embodiments 1-6 includes, the operations further comprising building or updating a unified model of aggregate physics content of the one or more hosted applications, the unified model to be used by the coordinating, by the host application, of the interactions among the one or more hosted applications.

In Embodiment 8, the subject matter of Embodiments 1-7 includes, the operations further comprising: a subgraph of the scene graph being transmitted to a worker host application for rendering; receiving, from the worker host application, the rendered subgraph; and wherein displaying, by the host application, of a display based on the generated aggregated output further comprises combining, by the host application, of the rendered subgraph with locally rendered scene graph content.

In Embodiment 9, the subject matter of Embodiments 1-8 includes, wherein each application of the host application and the one or more hosted applications comprises application logic that is separate from input/output (I/O) requirements of a platform on which the application is executed.

In Embodiment 10, the subject matter of Embodiment 9 includes, wherein one of the hosted applications is a sandboxed plug-in application, the sandboxed plug-in application being one of at least a user-generated content (UGC) application, a chat application, a streaming tool, a minigame, or a playable ad.

Embodiment 11 is at least one machine-readable medium including instructions that, when executed by processing circuitry, cause the processing circuitry to perform operations to implement any of Embodiments 1-10.

Embodiment 12 is an apparatus comprising means to implement any of Embodiments 1-10.

Embodiment 13 is a system to implement any of Embodiments 1-10.

Embodiment 14 is a method to implement any of Embodiments 1-10.

### Glossary

“CARRIER SIGNAL” in this context refers to any intangible medium that is capable of storing, encoding, or carrying instructions for execution by the machine, and includes digital or analog communications signals or other intangible medium to facilitate communication of such instructions. Instructions may be transmitted or received over the network using a transmission medium via a network interface device and using any one of a number of well-known transfer protocols.

“CLIENT DEVICE” in this context refers to any machine that interfaces to a communications network to obtain resources from one or more server systems or other client devices. A client device may be, but is not limited to, a mobile phone, desktop computer, laptop, portable digital assistants (PDAs), smart phones, tablets, ultra books, netbooks, laptops, multi-processor systems, microprocessor-based or programmable consumer electronics, game consoles, set-top boxes, or any other communication device that a user may use to access a network.

“COMMUNICATIONS NETWORK” in this context refers to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network and the coupling may be a Code Division Multiple Access (CDMA) connection, a Global System for Mobile communications (GSM) connection, or other type of cellular or wireless coupling. In this example, the coupling may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

“MACHINE-READABLE MEDIUM” in this context refers to a component, device or other tangible media able to store instructions and data temporarily or permanently and may include, but is not be limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions (e.g., code) for execution by a machine, such that the instructions, when executed by one or more processors of the machine, cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

“COMPONENT” in this context refers to a device, physical entity or logic having boundaries defined by function or subroutine calls, branch points, application program interfaces (APIs), or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various example embodiments, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a Field-Programmable Gate Array (FPGA) or an Application Specific Integrated Circuit (ASIC). A hardware component may also include programmable logic or circuitry that is temporarily configured by software to perform certain operations. For example, a hardware component may include software executed by a general-purpose processor or other programmable processor. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software) may be driven by cost and time considerations. Accordingly, the phrase “hardware component”(or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)). The performance of certain of the operations may be distributed among the processors, not only residing within a single machine, but deployed across a number of machines. In some example embodiments, the processors or processor-implemented components may be located in a single geographic location (e.g., within a home environment, an office environment, or a server farm). In other example embodiments, the processors or processor-implemented components may be distributed across a number of geographic locations.

“PROCESSOR” in this context refers to any circuit or virtual circuit (a physical circuit emulated by logic executing on an actual processor) that manipulates data values according to control signals (e.g., “commands”, “op codes”, “machine code”, etc.) and which produces corresponding output signals that are applied to operate a machine. A processor may, for example, be a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC) or any combination thereof. A processor may further be a multi-core processor having two or more independent processors (sometimes referred to as “cores”) that may execute instructions contemporaneously.

“TIMESTAMP” in this context refers to a sequence of characters or encoded information identifying when a certain event occurred, for example giving date and time of day, sometimes accurate to a small fraction of a second.

“TIME DELAYED NEURAL NETWORK (TDNN)” in this context, a TDNN is an artificial neural network architecture whose primary purpose is to work on sequential data. An example would be converting continuous audio into a stream of classified phoneme labels for speech recognition.

“BI-DIRECTIONAL LONG-SHORT TERM MEMORY (BLSTM)” in this context refers to a recurrent neural network (RNN) architecture that remembers values over arbitrary intervals. Stored values are not modified as learning proceeds. RNNs allow forward and backward connections between neurons. BLSTM are well-suited for the classification, processing, and prediction of time series, given time lags of unknown size and duration between events.

“ASSETS” in this context refer to meshes, materials, textures, shader and/or animation rig information, fonts, audio clips, sprites, prefabs, UI elements, video clips (2D, stereo, spatial), navigation meshes, component data, script byte code, lighting representations (light probes, environment probes, lightmaps, etc.), blend shapes, animation clips, animation graphs, collision meshes and materials, low-level GPU assets. Textures can be of one or more types (e.g., 1D,2D,3D, cubemap) in both native (compressed) and universal formats, shaders in various representations (bytecode, source code, human readable encodings (e.g., MaterialX, UsdShade)). Low-level GPU assets include pipeline state objects (PSOs), buffers (e.g., texture buffers, vertex buffers, index buffers, constant buffers, compute buffers), shader resources (SRVs and UAVs), sampler state, render targets, and so forth.

“ENTITIES” in this context refer to game objects and/or scene graph nodes, among other entity types.). Entities such as scene graph nodes are an example of scene data, which can refer to runtime state information used to simulate and/or render a scene. Each entity includes a 2D or 3D transform (in the context of a transform hierarchy), a name, ID, lifecycle state information such as active/enabled/visible flags, debug information, and/or additional hierarchical relationships (e.g., namespace and/or physics hierarchies separate from the transform hierarchy).

“COMPONENTS (SCENE DATA)” in this context refer to modular elements associated with entities. Components can be individually added to and/or removed from entities. When added to an entity, a component can activate or turn off one or more specific behaviors (e.g., rendering a mesh, playing a sound, etc.). A component is characterized by properties and/or data (e.g., mesh information, material information, shader property values, etc.), simulation behavior and/or rendering behavior (behaviors being encoded as functions associated with the component). For example, a MeshRenderer component includes properties and/or data such as a reference to a mesh (an asset), a material (an asset) to be used to render that mesh, and/or one or more flags indicating if the component is enabled and/or visible at a given time. An example ParticleSystem component includes a mesh, a material and/or hundreds of properties (values, curves, colors, enums, and so forth) associated with lifetime information, delay information, speed, start and/or end color, forces, current time, and so forth. An example light component can include a color and/or a position. In some embodiments, components can be output components. Output components contribute to the final output, such as rendering, audio and/or other output signals. Output components are replicated over to a remote host to recreate the scene. Output components include, for example: Camera, Light, MeshRenderer, SkinnedMeshRenderer, SpriteRenderer, ParticleSystem, ParticleRenderer, LineRenderer, TrailRenderer, TextRenderer, CanvasRenderer, SpriteMask, ReflectionProbe, LOD Group, Terrain, Skybox, OcclusionCulling, PostProcessing, Visual Effects (LenseFlare, Projector, Decal), AudioSource, Audio Listener, UI ComponentsTerrain, Tilemap, VideoPlayback, and so forth. In some embodiments, components can be simulation components that relate to the logic of an application, but not to the output of an application. Simulation components can be omitted from sync-ing operations (or included if desired). Simulation components include, for example: Animator, NavMeshAgent, NavMeshObstacle, EventSystem, CharacterController, user-created script components that implement particular games (e.g., MonoBehaviours, etc.), and so forth. Additional components of interest can include colliders, rigid bodies, joints, forces, or animators. Colliders, rigid bodies, joints and/or forces can be included in sync-ing operations (e.g., between server and remote host, etc.) to enable host-side input ray tracing and/or a shared physics world. Animators can be simulation components (e.g., if host overhead is acceptable), or, alternatively, be considered output components (e.g., if sync-ing them over the network is acceptable).

“SHADER” in this context refers to a program that runs on a GPU, a CPU, a TPU and so forth. In the following, a non-exclusive listing of types of shaders is offered. Shader programs may be part of a graphics pipeline. Shaders may also be compute shaders or programs that perform calculations on a CPU or a GPU (e.g., outside of a graphics pipeline, etc.). Shaders may perform calculations that determine pixel properties (e.g., pixel colors). Shaders may refer to ray tracing shaders that perform calculations related to ray tracing. A shader object may (e.g., an instance of a shader class) may be a wrapper for shader programs and other information. A shader asset may refer to a shader file (or a “.shader” extension file), which may define a shader object.

Throughout this specification, plural instances may implement resources, components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components.

As used herein, the term “or” may be construed in either an inclusive or exclusive sense. The terms “a” or “an” should be read as meaning “at least one,” “one or more,” or the like. The presence of broadening words and phrases such as “one or more,” “at least,” “but not limited to,” or other like phrases in some instances shall not be read to mean that the narrower case is intended or required in instances where such broadening phrases may be absent. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. The specification and drawings are, accordingly, to be regarded in an illustrative rather than a restrictive sense.

It will be understood that changes and modifications may be made to the disclosed embodiments without departing from the scope of the present disclosure. These and other changes or modifications are intended to be included within the scope of the present disclosure.

What is claimed is:

1. A non-transitory computer-readable storage medium storing instructions that, when executed by at least one processor, cause the at least one processor to perform operations comprising:
maintaining a polyspatial graph specifying an application hierarchy comprising at least a host application, one or more hosted applications to be executed within the host application, one of the one or more hosted applications corresponding to an intermediate host application for an additional application; and
executing the host application and the one or more hosted applications, the executing comprising:
receiving, at the host application, input to be transmitted to the one or more hosted applications;
coordinating, by the host application, interactions among the one or more hosted applications;
generating, by the host application, of an aggregated output based on outputs of the one or more hosted applications, the aggregated output comprising a scene graph; and
displaying, by the host application, of a display based on the generated aggregated output.

2. The non-transitory computer-readable storage medium of claim 1, wherein the application hierarchy further comprises the additional application to be executed within the intermediate host application, the executing comprising:
receiving, at the intermediate host application, the input from the host application:
transmitting, at the intermediate host application, the input to the additional application;
receiving at the intermediate host application, output from the additional application; and
transmitting, at the intermediate host application, the output from the additional application to the host application.

3. The non-transitory computer-readable storage medium of claim 1, wherein:
the host application and the one or more hosted applications share a logical 3D space;
each hosted application of the one or more hosted applications controls a volume or window enabled to be moved, resized or change shape; and
the coordinating, by the host application, of interactions among the one or more hosted applications comprises resolving conflicts among the hosted applications caused by volume overlaps in the logical 3D space for volumes or windows controlled by the hosted applications.

4. The non-transitory computer-readable storage medium of claim 3, wherein an additional application is connected, over a network, to the host application or to one of the one or more hosted applications, the additional application sharing the logical 3D space or an additional 3D space associated with the logical 3D space.

5. The non-transitory computer-readable storage medium of claim 1, wherein:
an application of the one or more hosted applications is associated with content or state data; and
upon detecting changes to the content or the state data wherein the changes comprise one or more of updates to assets, updates to properties of materials or updates to transformations, the application transmits the detected changes to at least the host application.

6. The non-transitory computer-readable storage medium of claim 1, wherein generating, by the host application, of the aggregated output is further based on local content of the host application or a local user interface (UI).

7. The non-transitory computer-readable storage medium of claim 1, the operations further comprising building or updating a unified model of aggregate physics content of the one or more hosted applications, the unified model to be used by the coordinating, by the host application, of the interactions among the one or more hosted applications.

8. The non-transitory computer-readable storage medium of claim 1, the operations further comprising:
a subgraph of the scene graph being transmitted to a worker host application for rendering;
receiving, from the worker host application, the rendered subgraph; and
wherein displaying, by the host application, of a display based on the generated aggregated output further comprises combining, by the host application, of the rendered subgraph with locally rendered scene graph content.

9. The non-transitory computer-readable storage medium of claim 1, wherein each application of the host application and the one or more hosted applications comprises application logic that is separate from input/output (I/O) requirements of a platform on which the application is executed.

10. The non-transitory computer-readable storage medium of claim 9, wherein one of the hosted applications is a sandboxed plug-in application, the sandboxed plug-in application being one of at least a user-generated content (UGC) application, a chat application, a streaming tool, a minigame, or a playable ad.

11. A computer-implemented method comprising:
maintaining, at a computing device, a polyspatial graph specifying an application hierarchy comprising at least a host application, and one or more hosted applications to be executed within the host application, one of the one or more hosted applications corresponding to an intermediate host application for an additional application; and
executing the host application and the one or more hosted applications, the executing comprising:
receiving, at the host application, input to be transmitted to the one or more hosted applications;
coordinating, by the host application, interactions among the one or more hosted applications;
generating, by the host application, of an aggregated output based on outputs of the one or more hosted applications, the aggregated output comprising a scene graph; and
displaying, by the host application at the computing device, of a display based on the generated aggregated output.

12. The computer-implemented method of claim 11, wherein the application hierarchy further comprises the additional application to be executed within one of the hosted applications corresponding to an the intermediate host application, the executing comprising:
receiving, at the intermediate host application, the input from the host application:
transmitting, at the intermediate host application, the input to the additional application;
receiving at the intermediate host application, output from the additional application; and
transmitting, at the intermediate host application, the output from the additional application to the host application.

13. The computer-implemented method of claim 11, wherein:
the host application and the one or more hosted applications share a logical 3D space;
each hosted application of the one or more hosted applications controls a volume or window that is enabled to be moved, resized or change shape; and
the coordinating, by the host application, of interactions among the one or more hosted applications comprises resolving conflicts among the hosted applications caused by volume overlaps in the logical 3D space for volumes or windows controlled by the hosted applications.

14. The computer-implemented method of claim 13, wherein an additional application is connected, over a network, to the host application or to one of the one or more hosted applications, the additional application sharing the logical 3D space or an additional 3D space associated with the logical 3D space.

15. The computer-implemented method of claim 11, wherein:
an application of the one or more hosted applications is associated with content or state data; and
upon detecting changes to the content or the state data wherein the changes comprise one or more of updates to assets, updates to properties of materials or updates to transformations, the application transmits the detected changes to at least the host application.

16. The computer-implemented method of claim 11, wherein generating, by the host application, of the aggregated output is further based on local content of the host application or a local user interface (UI).

17. The computer-implemented method of claim 11, further comprising building or updating a unified model of aggregate physics content of the one or more hosted applications, the unified model to be used by the coordinating, by the host application, of the interactions among the one or more hosted applications.

18. The computer-implemented method of claim 11, further comprising:
a subgraph of the scene graph being transmitted to a worker host application for rendering;
receiving, from the worker host application, the rendered subgraph; and
wherein displaying, by the host application, of a display based on the generated aggregated output further comprises combining, by the host application, of the rendered subgraph with locally rendered scene graph content.

19. The computer-implemented method of claim 11, wherein each application of the host application and the one or more hosted applications comprises application logic that is separate from input/output (I/O) requirements of a platform on which the application is executed.

20. A system comprising:
one or more computer processors;
one or more computer memories; and
a set of instructions stored in the one or more computer memories, the set of instructions configuring the one or more computer processors to perform operations, the operations comprising:
maintaining a polyspatial graph specifying an application hierarchy comprising at least a host application, and one or more hosted applications to be executed within the host application, one of the one or more hosted applications corresponding to an intermediate host application for an additional application; and
executing the host application and the one or more hosted applications, the executing comprising:
receiving, at the host application, input to be transmitted to the one or more hosted applications;
coordinating, by the host application, interactions among the one or more hosted applications;
generating, by the host application, of an aggregated output based on outputs of the one or more hosted applications, the aggregated output comprising a scene graph; and
displaying, by the host application, of a display based on the generated aggregated output.
